(19) United States
(12) Patent Application Publication
(10) Pub. No.: US 2025/0337474 A1
(43) Pub. Date: Oct. 30, 2025

(54) BEAM BLOCKAGE EVENT PREDICTION

(71) Applicant: QUALCOMM Incorporated, San Diego, CA (US)

(72) Inventors: Hamed PEZESHKI, San Diego, CA (US); Qiaoyu LI, Beijing (CN); Mahmoud TAHERZADEH BOROUJENI, San Diego, CA (US); Tao LUO, San Diego, CA (US)

(21) Appl. No.: 18/871,417

(22) PCT Filed: Jul. 11, 2022
(86) PCT No.: PCT/CN2022/104814

§ 371 Date: Dec. 3, 2024

(51) Int. Cl. H04B 7/06; H04B 17/318

(52) U.S. Cl. CPC H04B 7/06952; H04B 17/328

(57) ABSTRACT

A first network node includes processor. The processor may perform a method and is configured to receive a plurality of reference signals. Each of the plurality of reference signals corresponds to a respective identifier of a plurality of identifiers. The processor is also configured to transmit prediction information indicative of a predicted beam blockage event. The prediction information is based on measurement information corresponding to the plurality of reference signals during a time period. A second network node is configured to transmit a plurality of reference signals. Each reference signal of the plurality of reference signals corresponds to a respective identifier of a plurality of identifiers. The second network node receives measurement information corresponding to the plurality of reference signals during a time period and transmits prediction information indicative of a predicted beam blockage event. The prediction information is based on the measurement information.

### TECHNICAL FIELD

The technology disclosed herein relates generally to beam failures and, more particularly, to criteria used to predict beam blockage events and to the use of those criteria in the service of predicting beam blockage events.

### INTRODUCTION

The use of millimeter wave (mmWave) communication systems facilitates a use of large bandwidths of the radio frequency spectrum (e.g., in comparison to the segments of the radio frequency spectrum utilized in sub-6 GHz communication systems). Consequently, use of the mmWave spectrum and the associated large bandwidths made available by such use permit increases in the amounts of data transferred via the mmWave communication systems. However, mmWaves present issues that affects data transfer, including the issue of atmospheric propagation, for example. To overcome losses related to atmospheric propagation of mmWaves, relatively high gain directional antenna beams may be formed, which may be used to direct signals from a base station to a given user equipment. The mmWave frequencies allow for antenna systems, such as phased array antenna systems used in 5G, to provide numerous spatially directed beams with narrow beamwidths and relatively high gain, where the numerous spatially directed beams may be directed toward multiple corresponding numbers of user equipment devices. The use of relatively narrow and relatively high gain beams may help overcome the atmospheric propagation losses attendant to mmWave frequencies. Additionally, mmWave communication may be blocked by obstacles such as buildings, trucks, busses, tunnels, and, in general, man-made or natural (e.g., trees, mountains) objects.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and neither identifies key or critical elements of all aspects of the disclosure nor delineates the scope of any or all aspects of the disclosure. Its sole purpose is to present some concepts of one or more aspects of the disclosure in a form as a prelude to the more detailed description that is presented later.

According to one aspect, a first network node is described. The first network node includes a memory and a processor coupled to the memory. In the example, the processor is configured to receive a plurality of reference signals. Each of the plurality of reference signals corresponds to a respective identifier of a plurality of identifiers. The processor is also configured to transmit prediction information indicative of a predicted beam blockage event. According to this aspect, the prediction information is based on measurement information corresponding to the plurality of reference signals during a time period.

In another aspect, a method at a first network node is disclosed. The method includes receiving a plurality of reference signals. According to this aspect, each of the plurality of reference signals corresponds to a respective identifier of a plurality of identifiers. The method also includes transmitting prediction information indicative of a predicted beam blockage event. The prediction information is based on measurement information corresponding to the plurality of reference signals during a time period.

In another aspect, a first network node is disclosed. The first network node includes a memory and a processor coupled to the memory. According to this aspect, the processor is configured to transmit a plurality of reference signals. Each reference signal of the plurality of reference signals corresponds to a respective identifier of a plurality of identifiers. The processor is also configured to receive measurement information corresponding to the plurality of reference signals during a time period and transmit prediction information indicative of a predicted beam blockage event. According to this aspect the prediction information is based on the measurement information.

These and other aspects will become more fully understood upon a review of the detailed description, which follows. Other aspects, features, and examples will become apparent upon reviewing the following description of specific exemplary aspects in conjunction with the accompanying figures. While features may be disclosed relative to certain examples and figures, all examples can include one or more of the advantageous features disclosed herein. In other words, while one or more examples may be disclosed as having certain advantageous features, one or more of such features may also be used in accordance with the various examples disclosed herein. Similarly, while examples may be disclosed herein as device, system, or method examples, it should be understood that such examples can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a schematic illustration of an example of a radio access network (RAN) according to some aspects of the disclosure.

FIG. 3 is an expanded view of an exemplary subframe, showing an orthogonal frequency divisional multiplexing (OFDM) resource grid according to some aspects of the disclosure.

FIG. 4 is a schematic diagram illustrating some aspects of beam management according to some aspects of the disclosure.

FIGS. 5A, 5B, and 5C are diagrams illustrating examples of downlink beam management procedures, including downlink beam refinement procedures, between a network entity and a user equipment according to some aspects of the disclosure.

FIG. 6 is a block diagram depicting a use of a neural network, artificial intelligence and/or machine learning system in the collection of data according to some aspects of the disclosure.

FIG. 7 is a spectrogram that depicts beam index versus time as a function of reference signal received power according to one example provided in the disclosure.

FIGS. 8A and 8B are, respectively, a spectrogram that depicts beam index versus time as a function of reference signal received power, and a graph indicating beam blockage versus time, according to one example provided in the disclosure.

FIG. 9A is a first spectrogram of mean values of reference signal received power (RSRP) of a plurality of beam blockage prediction-reference signals over beams and over time, according to one example provided in the disclosure.

FIG. 9B is a second spectrogram of a standard deviation of the RSRP of the beam blockage prediction-reference signals of FIG. 9A over the same beams and over the same time as depicted in the example of FIG. 9A.

FIG. 10 is an aerial view of a traffic intersection according to some aspects of the disclosure.

FIG. 11 is an aerial view of a portion of a four-lane divided highway according to some aspects of the disclosure.

FIG. 12 is a block diagram illustrating an example of a hardware implementation of a wireless communication device employing a processing system according to some aspects of the disclosure.

FIG. 13 is a flow chart illustrating an exemplary process at a wireless communication device according to some aspects of the disclosure.

FIG. 14 is a block diagram illustrating an example of a hardware implementation of a network access node employing a processing system according to some aspects of the disclosure.

FIG. 15 is a flow chart illustrating an exemplary process at a network access node according to some aspects of the disclosure.

### DETAILED DESCRIPTION

The detailed description and the drawings disclose various configurations and do not represent the only configurations in which the concepts described herein may be practiced. This disclosure includes specific details for the purpose of providing a thorough understanding of various concepts. However, these concepts may be practiced without these specific details. In some examples, well-known structures and components are shown in block diagram form in order to avoid obscuring concepts.

While aspects and examples are described in this disclosure by illustration to some examples, additional implementations and use cases may come about in many different configurations, arrangements, and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some examples, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

Described herein are methods and apparatus directed toward predicting beam blockage events, which, particularly, but not exclusively, may occur in connection line-of-sight beam pair links utilized in the mmWave spectrum. The beam blockage events may be temporary, lasting for a predicted approximate duration. A pre-blockage signature may be identified based on statistical measures (e.g., measures of variance) of reference signal received power across beam identifiers of a plurality of beams and across time. User equipment that may predict beam blockage events based on the pre-blockage signature may avoid waste of overhead that may otherwise be expended by unnecessary entry into beam failure recovery and/or radio link failure processes.

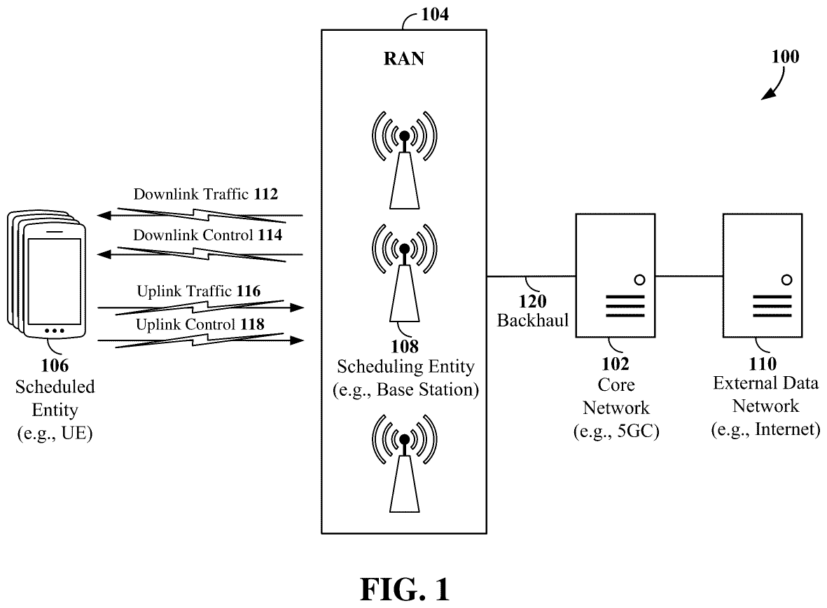

The various concepts presented throughout this disclosure may be implemented across a broad variety of telecommunication systems, network architectures, and communication standards. Referring now to FIG. 1, as an illustrative example, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF-chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as disclosed herein, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink control information 118 and/or downlink control information 114 and/or uplink traffic 116 and/or downlink traffic 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC), or any other suitable standard or configuration.

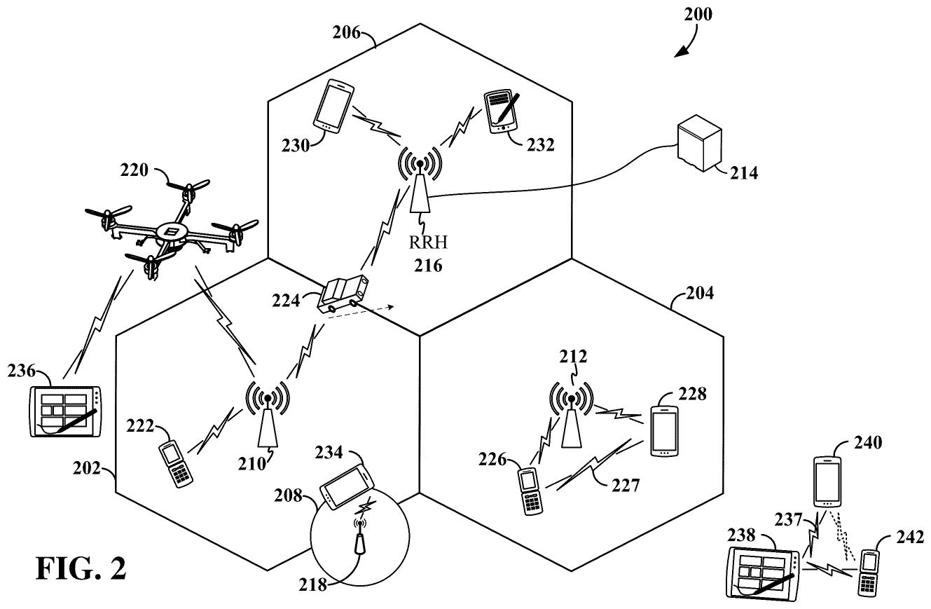

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHZ), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full-duplex (SBFD), also known as flexible duplex.

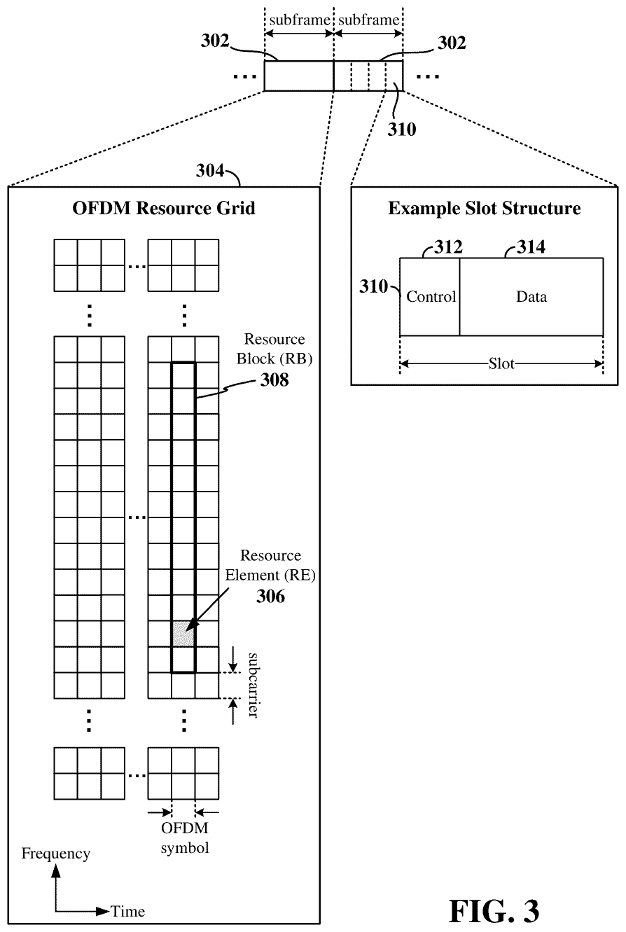

Various aspects of the present disclosure will be described with reference to an OFDM waveform, schematically illustrated in FIG. 3. Various aspects of the present disclosure may be applied to an SC-FDMA waveform in substantially the same way as described herein. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid according to some aspects of the disclosure. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESETO), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data. Such data may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, disclosed herein. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIGS. 1, 2, and 3 are not necessarily all of the channels or carriers that may be utilized between devices, and other channels or carriers may be utilized in addition to those illustrated, such as other traffic, control, and feedback channels.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

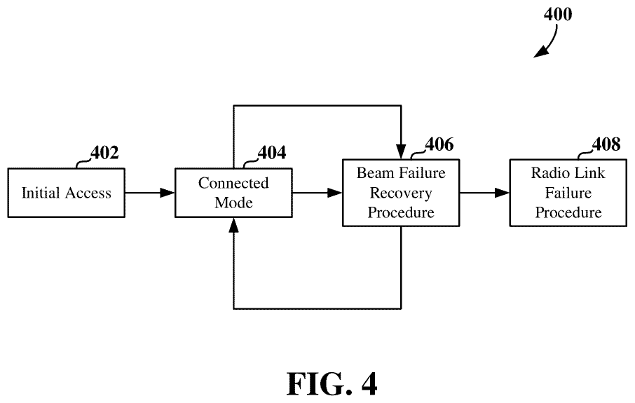

FIG. 4 is a schematic diagram 400 illustrating some aspects of beam management according to some aspects of the disclosure. A user equipment (not shown) may obtain initial access 402 to a network via a base station (not shown). The user equipment may be any user equipment (UE), wireless communication device, or scheduled entity as shown and described, for example, in connection with FIGS. 1 and/or 2. The base station may be any base station, network access node, gNB, or scheduling entity, as shown and described, for example, in connection with FIGS. 1 and/or 2. In some examples, the base station may be implemented as an aggregated base station or a disaggregated base station. In a disaggregated base station architecture, the base station may include one or more of a central unit (CU), a distributed unit (DU), or a radio unit (RU).

The user equipment may enter into a random access channel (RACH) procedure to obtain initial access. The UE and network access node may enter into a synchronization process during the RACH procedure. The network access node may transmit a plurality of synchronization signals during the synchronization process. Each synchronization signal may be transmitted in a corresponding plurality of downlink beams pointing in a corresponding plurality of directions. The process may be referred to as beam sweeping. In beam sweeping, the network access node sweeps its downlink beams by transmitting a downlink beam in a specific direction at a specific time, then transmitting a next downlink beam in a next direction at a next time, and so on. A different respective synchronization signal block (SSB) or channel state information reference signal (CSI-RS), or as described herein a beam blockage prediction-reference signal, may be used with each respective downlink beam during a beam sweeping procedure. The beam sweep procedure may utilize relatively wide beams, referred to herein as Layer 1 (L1) beams.

The UE may evaluate the quality of the SSB or CSI-RS and select a beam with a best quality from among those beams being swept by the network access node. The UE may inform the network access node of the selection using, for example, a physical random access channel (PRACH) resource mapped to each respective downlink beam. The user equipment may utilize a CSI report to provide the network access node with an identity of the beam with the best quality.

With respect to the beam blockage prediction-reference signal, the UE may measure and collect the RSRP of the beam blockage prediction-reference signals over beams and over time for aspects related to beam failure prediction.

According to one aspect, a process of beam management referred to herein as P1/P2/P3 may be practiced to refine the downlink beam direction. In short, during the P1 process, the network access node sweeps the L1 beams as described above and the user equipment selects the best beam and reports the identity of the best beam to the network access node, substantially as described above. During the P2 process, the network access node may refine the beam direction by sweeping narrower beams over narrower ranges and the user equipment may again select the best beam and report the identity of the (refined) best beam to the network access node. During the P3 process, if the user equipment supports beamforming, the network access node may fix the best beam identified by the user equipment (e.g., by repetitively transmitting the best beam identified by the user equipment) and the user equipment (utilizing its beamforming circuitry) may adjust its receive beam to effectively point in the direction of the network access node. There may be another process referred to herein as the U1/U2/U3 process, which may be a corresponding process but used to refine an uplink beam direction, but its explanation is omitted herein for the sake of brevity.

Upon successfully completing the random access procedure, the UE may enter a connected mode 404 with the network access node. From time to time, a beam failure may be detected and may be recovered from (as indicated by the clockwise arrows joining beam failure recovery procedure 406 and connected mode 404.

Upon beam failure detection, the network access node may configure the user equipment with a beam failure detection reference signal, different from the beam blockage prediction-reference signal. By way of example, the beam failure detection reference signal (BFD-RS) may be an SSB or a CSI-RS. The user equipment may declare a beam failure when a number of beam failure instance indications from the physical layer reach a configured threshold before a configured timer expires. SSB-based beam failure detection may be based on the SSB associated with the initial DL BWP. It may be configured for the initial DL BWPs and DL BWPs containing the SSB associated with the initial DL BWP. For other DL BWPs, beam failure detection may be performed based on CSI-RS. For example, the user equipment may trigger a beam failure recovery procedure 406 based on the user equipment detecting the beam failure on the PCell. In some aspects, according to a beam failure recovery procedure a user equipment may lose a first link associated with a first beam yet may possess an ability to establish a second link with a second beam by completing a random access procedure via the second beam. Accordingly, the beam failure recovery procedure 406 may include initiating a random access procedure on a primary cell (PCell). Additionally, reference to the triggering of the beam failure recovery procedure 406 being based on the detection of the beam failure on the PCell may, in some aspects, refer to the beam failure recovery procedure 406 being triggered in response to the detection of the beam failure on the PCell. The beam failure recovery procedure 406 associated with a PCell may be considered complete upon completing the random access procedure. A similar procedure may be followed for a secondary cell (SCell).

In some examples, a user equipment may not be able to recover a link after a beam failure occurs. For example, in an RRC connected mode (e.g., connected mode 404), a user equipment may perform radio link monitoring (RLM) in an active BWP based on reference signals (e.g., SSB and/or CSI-RS). By way of example and without limitation, a user equipment may enter into radio link failure procedure 408 after the expiry of a radio problem timer started after indication of radio problems from the physical layer, after the expiry of a timer started upon triggering a measurement report for a measurement identity for which the timer has been configured while another radio problem timer is running, after a random access procedure failure, or after a radio link control (RLC) failure. Other criteria may also cause a user equipment to enter into a radio link failure procedure 408.

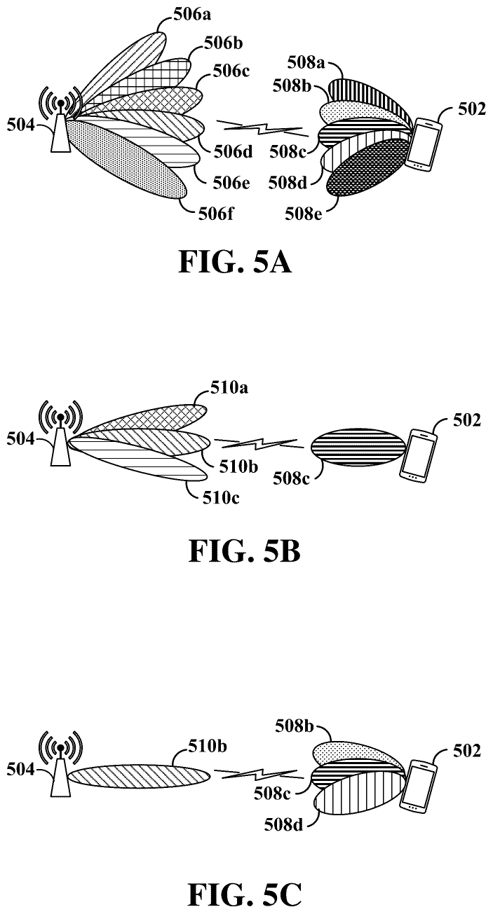

FIGS. 5A, 5B, and 5C are diagrams illustrating examples of downlink beam management procedures, including downlink beam refinement procedures, between a network entity 504 and a UE 502 according to some aspects. The network entity 504 may be any of the base stations (e.g., gNBs) or scheduling entities illustrated in FIGS. 1 and/or 2, and the UE 502 may be any of the UEs or scheduled entities illustrated in FIGS. 1 and/or 2. In some examples, the network entity 504 may be implemented as an aggregated base station or a disaggregated base station. In a disaggregated base station architecture, the network entity 504 may include one or more of a central unit (CU), a distributed unit (DU), or a radio unit (RU).

The network entity 504 may generally have the capability to communicate with the UE 502 using one or more transmit beams, and the UE 502 may further have the capability to communicate with the network entity 504 using one or more receive beams. As used herein, the term transmit beam refers to a beam on the network entity 504 that may be utilized for downlink or uplink communication with the UE 502. In addition, the term receive beam refers to a beam on the UE 502 that may be utilized for downlink or uplink communication with the network entity 504.

In the example shown in FIG. 5A, the network entity 504 is configured to generate a plurality of transmit beams 506a-506f, each associated with a different spatial direction. Each of the transmit beams 506a-506f may be referenced by a respective beam ID (e.g., an SSB resource indicator (SRI), a beam index value). In addition, the UE 502 is configured to generate a plurality of receive beams 508a-508e, each associated with a different spatial direction. Each of the receive beams 508a-508e may further be referenced by a respective beam ID (e.g., via a quasi-co-location (QCL) relation to an SSB resource indicator (SRI), CSI-RS resource indicator (CRI), or SRS resource indicator (SRI)). In some examples, the transmit beams 506a-506h on the network entity 504 and the receive beams 508a-508e on the UE 502 may be spatially directional mmWave beams, such as FR2, FR4-a, FR4-1, FR4, or FR5 beams. It should be noted that while some beams are illustrated as adjacent to one another, such an arrangement may be different in different aspects. For example, transmit beams 506a-506f transmitted during a same symbol may not be adjacent to one another. In some examples, the network entity 504 and UE 502 may each transmit more or less beams distributed in all directions (e.g., 360 degrees) and in three-dimensions. In addition, the transmit beams 506a-506f may include beams of varying beam width. For example, the network entity 504 may transmit certain signals (e.g., SSBs) on wider beams and other signals (e.g., CSI-RSs) on narrower beams.

The network entity 504 and UE 502 may select one or more transmit beams 506a-506f on the network entity 504 and one or more receive beams 508a-508e on the UE 502 for communication of uplink and downlink signals therebetween using a beam management procedure. In one example, as shown in FIG. 5A, during initial cell acquisition, the UE 502 may perform a P1 beam management procedure to scan the plurality of transmit beams 506a-506f transmitted in a wide range beam sweep on the plurality of receive beams 508a-508e to select a beam pair link (e.g., one of the transmit beams 506a-506f and one of the receive beams 508a-508e) for a physical random access channel (PRACH) procedure for initial access to the cell. For example, periodic SSB beam sweeping may be implemented on the network entity 504 at certain intervals (e.g., based on the SSB periodicity). Thus, the network entity 504 may be configured to sweep or transmit an SSB on each of a plurality of wider transmit beams 506a-506f. The UE may measure the reference signal received power (RSRP) of each of the SSB transmit beams on each of the receive beams of the UE and select the transmit and receive beams based on the measured RSRP. In an example, the selected receive beam may be the receive beam on which the highest RSRP is measured and the selected transmit beam may have the highest RSRP as measured on the selected receive beam. The selected transmit beam and receive beam form a beam pair link (BPL) for the PRACH procedure. Here, the selected transmit beam may be associated with a particular RACH occasion that may be utilized by the UE 502 to transmit a PRACH preamble. In this way, the network entity 504 is informed of the selected transmit beam.

After completing the PRACH procedure, as shown in FIG. 5B, the network entity 504 and UE 502 may perform a P2 beam management procedure for beam refinement. For example, the network entity 504 may be configured to sweep or transmit a CSI-RS on each of a plurality of narrower transmit beams 510a-510c in a narrow range beam sweep for beam refinement. For example, each of the CSI-RS beams may have a narrower beam width than the SSB beams, and thus the transmit beams 510a-510c transmitted during the P2 procedure may each be a sub-beam of an SSB transmit beam selected during the P1 procedure (e.g., within the spatial direction of the SSB transmit beam). Transmission of the CSI-RS transmit beams may occur periodically (e.g., as configured via radio resource control (RRC) signaling by the gNB), semi-persistently (e.g., as configured via RRC signaling and activated/deactivated via medium access control-control element (MAC-CE) signaling by the gNB), or aperiodically (e.g., as triggered by the gNB via downlink control information (DCI)). The UE 502 is configured to scan the plurality of CSI-RS transmit beams 510a-510c on one or more of the plurality of receive beams. In the example shown in FIG. 5B, the UE 502 scans the CSI-RS transmit beams 510a-510c on a single receive beam 508c selected during the P1 procedure. The UE 502 then performs beam measurements (e.g., RSRP, signal to interference plus noise (SINR), etc.) of the transmit beams 510a-510c on the receive beam 508c to determine the respective beam quality of each of the transmit beams 510a-510c.

The UE 502 can then generate and transmit a Layer 1 (L1) measurement report (e.g., L1-RSRP or L1-SINR report), including the respective beam ID (e.g., CSI-RS resource indicator (CRI)) and beam measurement (e.g., RSRP) of one or more of the CSI-RS transmit beams 510a-510c to the network entity 504. The network entity 504 may then select one or more CSI-RS transmit beams on which to communicate with the UE 502. In some examples, the selected CSI-RS transmit beam(s) have the highest RSRP from the L1 measurement report. Transmission of the L1 measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The UE 502 may further refine the receive beam for each selected serving CSI-RS transmit beam to form a respective refined BPL for each selected serving CSI-RS transmit beam. For example, as shown in FIG. 5C, the UE 502 may perform a P3 beam management procedure to refine the UE-beam of a BPL. In an example, the network entity 504 may repeat transmission of a selected transmit beam 510b selected during the P2 procedure to the UE 502. The UE 502 can scan the transmit beam 510b using different receive beams 508b-508d to obtain beam measurements for the selected CSI-RS transmit beam 510b and select the best receive beam to refine the BPL for transmit beam 510b. In some examples, the selected receive beam to pair with a particular CSI-RS transmit beam 510b may be the receive beam on which the highest RSRP for the particular CSI-RS transmit beam is measured.

In some examples, in addition to configuring the UE 502 to perform P2 beam refinement (e.g., CSI-RS beam measurements), the network entity 504 may configure the UE 502 to perform a P1 beam management procedure (e.g., SSB beam measurements) outside of a RACH procedure and to provide an L1 measurement report containing beam measurements of one or more SSB transmit beams 506a-506f as measured on one or more of the receive beams 508a-508e. In this example, the L1 measurement report may include multiple RSRPs for each transmit beam, with each RSRP corresponding to a particular receive beam to facilitate selection of BPL(s). For example, the network entity 504 may configure the UE 502 to perform SSB beam measurements and/or CSI-RS beam measurements for various purposes, such as beam failure detection (BFD), beam failure recovery (BFR), cell reselection, beam tracking (e.g., for a mobile UE 502 and/or network entity 504), or other beam optimization purpose.

In one example, a single CSI-RS transmit beam (e.g., beam 510b) on the network entity 504 and a single receive beam (e.g., beam 508c) on the UE may form a single BPL used for communication between the network entity 504 and the UE 502. In another example, multiple CSI-RS transmit beams (e.g., beams 510a, 510b, and 510c) on the network entity 504 and a single receive beam (e.g., beam 508c) on the UE 502 may form respective BPLs used for communication between the network entity 504 and the UE 502. In another example, multiple CSI-RS transmit beams (e.g., beams 510a, 510b, and 510c) on the network entity 504 and multiple receive beams (e.g., beams 508c and 508d) on the UE 502 may form multiple BPLs used for communication between the network entity 504 and the UE 502. In this example, a first BPL may include transmit beam 510b and receive beam 508c, a second BPL may include transmit beam 510a and receive beam 508c, and a third BPL may include transmit beam 510c and receive beam 508d.

In addition to L1 measurement reports, the UE 502 can further utilize the beam reference signals to estimate the channel quality of the channel between the network entity 504 and the UE 502. For example, the UE 502 may measure the SINR of each received CSI-RS and generate a CSI report based on the measured SINR. The CSI report may include, for example, a channel quality indicator (CQI), rank indicator (RI), precoding matrix indicator (PMI), and/or layer indicator (LI). The scheduling entity may use the CSI report to select a rank for the scheduled entity, along with a precoding matrix and a MCS to use for future downlink transmissions to the scheduled entity. The MCS may be selected from one or more MCS tables, each associated with a particular type of coding (e.g., polar coding, LDPC, etc.) or modulation (e.g., binary phase shift keying (BPSK), quadrature phase shift keying (QPSK), 16 quadrature amplitude modulation (QAM), 64 QAM, 256 QAM, etc.). The LI may be utilized to indicate which column of the precoding matrix of the reported PMI corresponds to the strongest layer codeword corresponding to the largest reported wideband CQI.

To distinguish between the different types of reports (including CSI reports and L1 measurement reports) and different types of measurements, the network entity 504 may configure the UE 502 with one or more report settings. Each report setting may be associated with a reference signal configuration indicating a configuration of one or more reference signals (e.g., CSI-RSs) for use in generating the CSI report. In some examples, a report setting may be associated with a combined reference signal configuration.

In some examples, neural networks, artificial intelligence (AI), and/or machine learning (ML) may be applied to various use cases involving the air-interface between a user equipment 502 and the network entity 504. Neural networks/AI/ML may be used to improve performance, reduce, or better manage, complexity, for example.

Some use cases may relate to beam failure prediction and/or one or more processes of identifying a given beam failure event as a temporary beam failure event; where, due to the temporary nature of the beam failure event, there is a probability that the UE 502 may not need to enter a beam failure recovery process or a radio link failure process.

For example, possible uses of neural networks/AI/ML in connection with beam failure event prediction and/or processes of identifying a given beam failure event as a temporary beam failure event may enhance continuity of communications by predicting (e.g., determining, concluding) that a given beam failure event may be due to a temporary blockage of a transmit and receive beam pair link. For example, and without limitation, the temporary blockage may be due to a line-of-sight between the UE 502 and the network entity 504 being temporarily blocked by a passage, therebetween, of a truck or bus. In another example, and without any limitation, the temporary blockage may be due to a line-of-sight between the UE 502 and the network entity 504 being temporarily blocked due to the trajectory of the UE 502, where the trajectory may result in a man-made object (e.g., a building, a billboard, a tunnel, an overpass, etc.) or a natural object (e.g., a tree, a mountain, a canyon, etc.) temporarily interrupting the line-of-sight between the UE 502 and the network entity 504.

In these examples, the beams may be mm Wave beams and the temporary blockage may be due, at least in part, to the characteristics of mmWaves. For example, these characteristics may include, but are not limited to, a lowered ability of a mmWave signal (e.g., user traffic and/or control messaging) to penetrate man-made and natural objects, and a greater attenuation of a mmWave signal over a given distance, when compared to attenuation over the same given distance for a non-mmWave signal (e.g., a sub-6 GHZ signal). An ability to predict whether a given loss of signal is due to a temporary beam blockage event may reduce overhead that would otherwise be incurred if the UE determined it was necessary to enter into a beam failure recovery process, such as the beam failure recovery procedure 406 process as shown and described in connection with FIG. 4, or a radio link failure process, such as the radio link failure procedure 408 process as shown and described in connection with FIG. 4.

Neural networks/AI/ML may also be used in connection with beam management. For example, neural networks/AI/ML may contribute to beam failure prediction in the time domain, and/or in the spatial domain, for overhead and latency reduction and/or beam selection accuracy improvement.

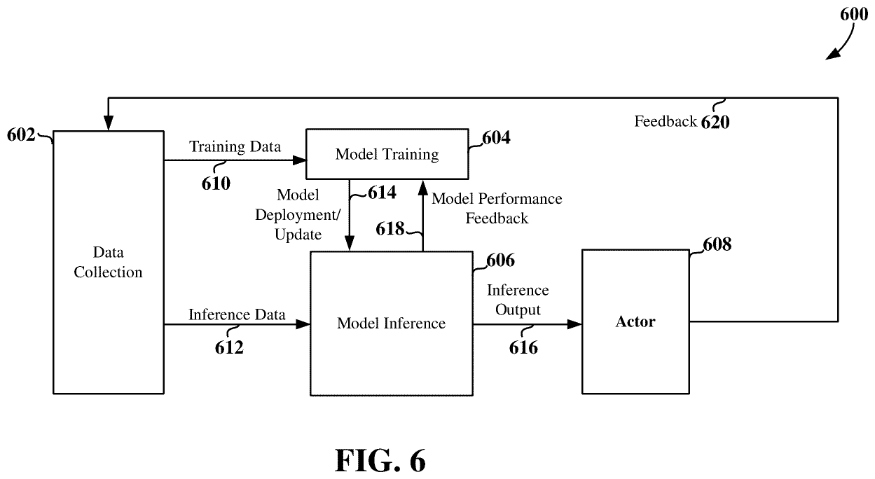

FIG. 6 is a block diagram depicting a use of a neural network/AI/ML system 600 in the collection of data according to some aspects of the disclosure. In FIG. 6, data collection 602 may be a circuit/function that provides input data to model training 604 and model inference 606 circuits/functions.

Examples of input data may include but are not limited to measurements from UEs or different network entities, feedback 620 from an actor 608 circuit/function, and inference output 616 from a neural network/AI/ML model inference 606 circuit/function obtained via the actor 608 circuit/function. As used herein, the actor 608 circuit/function may select a given action (e.g., may indicate that received data corresponds with a high probability to data indicative of a temporary beam blockage event).

Training Data 610 may be data used as input for the neural network/AI/ML model training 604 circuit/function.

Inference Data 612 may be used as input for the neural network/AI/ML model inference 606 circuit/function.

Model Training 604 may be a circuit/function that performs the ML model training, validation, and testing, which may generate model performance metrics as part of a model testing procedure. The model training 604 circuit/function may also be responsible for data preparation (e.g., data pre-processing and cleaning, formatting, and transformation) based on training data 610 delivered by the data collection 602 circuit/function, if required.

Model Deployment/Update 614 may be used to initially deploy a trained, validated, and tested neural network/AI/ML model to the model inference 606 circuit/function or to deliver an updated model to the model inference 606 circuit/function.

Model Inference 606 circuit/function may provide neural network/AI/ML model inference output (e.g., predictions or decisions). In some examples, the model inference 606 circuit/function may provide model performance feedback to the model training 604 circuit/function. The model inference 606 circuit/function may also be responsible for data preparation (e.g., data pre-processing and cleaning, formatting, and transformation) based on inference data 612 delivered by the data collection 602 circuit/function, if required.

The output of the neural network/AI/ML system 600 of FIG. 6 may be the inference output 616 of the neural network/AI/ML model produced by the model inference 606 circuit/function. According to some aspects, the details of the inference output 616 may be use case specific.

The model performance feedback 618 may be applied if certain information derived from the model inference 606 circuit/function is suitable for improvement of the neural network/AI/ML model trained in the model training 604 circuit/function. Feedback 620 from the actor 608 circuit/function or other network entities (e.g., via the data collection 602 circuit/function) may be used at the model inference 606 circuit/function to create the model performance feedback 618.

The actor 608 circuit/function may receive the output from the model inference 606 circuit/function and may trigger or perform corresponding actions. The actor 608 circuit/function may trigger actions directed to other entities or to itself.

Neural network/AI/ML-based predictive beam management may be employed according to some aspects of the disclosure. Neural network/AI/ML is well suited to beam management aspects because beam qualities and failures are identified via measurements. Without neural network/AI/ML, improvements in beam management may be associated with additional power needs and additional overhead to achieve improved performance. In some solutions without neural network/AI/ML, beam accuracy may be limited due to power and/or overhead restrictions. With non-neural network/AI/ML aspects, latency and/or throughput may be adversely impacted by beam failure and/or radio link failure processes (i.e., beam recovery efforts). However, the use of neural network/AI/ML in predictive beam management (e.g., in the time domain, and/or the spatial domain) may lead to reductions in power usage, reduction in overhead, and improved performance in connection with accuracy, latency, and/or throughput.

Neural network/AI/ML approaches to predictive beam management in general, and to mmWave blockage prediction in particular, may be categorized as follows:
Category I—use of sensory data such as camera, radar, lidar, etc. as input to the AI/ML process;
Category II—use of out-of-band measurements (e.g., FR1 band measurements) as input to the AI/ML process; and
Category III—use of in-band (e.g., mmWave) measurements and reliance on “wireless signatures” (also referred to herein as “pre-blockage signatures”) as input to the neural network/AI/ML process.
   The preceding categories are presented as examples and without limitation. Additional categories, or combinations of categories, are within the scope of the disclosure.

One example of Category III, mentioned above, may involve performing a beam sweep (as shown and described in connection with FIGS. 4 and 5), utilizing the beam blockage prediction-reference signals described above. The beam sweep may be performed at the transmitter/receiver with a certain periodicity and may further involve a reliance on RSRP measurement variations of the beam blockage prediction-reference signals across beams and over a particular time (e.g., a duration, a period). The collection of RSRP measurements across beams and over time may be used to create a spectrogram which may be applied, for example, to a neural network/AI/ML system as an input. The neural network/AI/ML system may be similar to the neural network/AI/ML system 600 as shown and described in connection with FIG. 6. The neural network/AI/ML system may be based on either a convolutional neural network (CNN) or a recurrent neural network (RNN), or both.

Using the RSRP measurement data (in the form of a spectrogram or another form) as input, the neural network/AI/ML system may be trained to perform any of the following actions: 1) predict blockage events (e.g., the occurrence of a blockage event); 2) predict blockage instances (e.g., a time of the occurrence of the blockage event); 3) predict blockage severity (e.g., a duration of the blockage event); and/or predict a bearing (e.g., a direction or position and/or a direction of movement) of an object corresponding to (or predicted to correspond to) the predicted beam blockage event. For example, a bearing of approximately 270 degrees and closing may indicate that the object is coming approximately from the West (if bearing is given relative to the Earth's magnetic field) or from the left (if bearing is given relative to the UE and the forward direction of the UE is aligned with zero degrees) and that the object is coming toward the UE, such as in an instance of a bus crossing a traffic intersection from left to right and perpendicular to a vehicle/UE waiting to cross the traffic intersection).

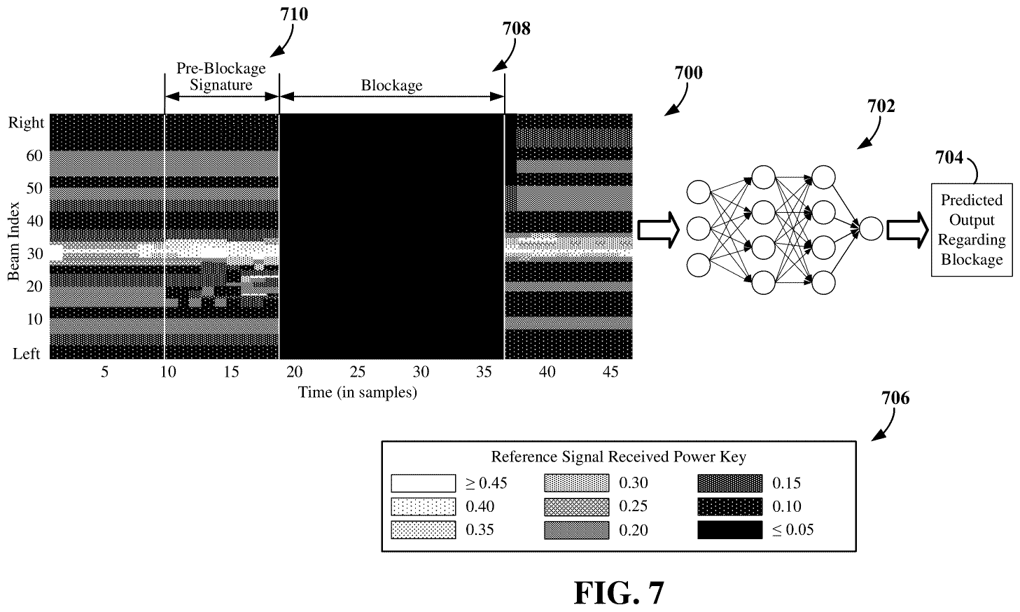

FIG. 7 is a spectrogram 700 that depicts beam index values (e.g., beam identifiers) versus time (in samples) as a function of reference signal received power (RSRP) according to one example provided in the disclosure. FIG. 7 additionally depicts an application of the spectrogram 700 to a neural network/AI/ML system 702, and the predicted output 704 of the neural network/AI/ML system 702 regarding blockage according to aspects of the disclosure. In the example of FIG. 7, beam index values from 0 to 70 in steps of 10 are depicted on the vertical axis. Decreasing beam index values indicate an azimuth direction moving counterclockwise (i.e., to the left) relative to an undefined reference beam index value, while increasing beam index values indicate an azimuth direction moving clockwise (i.e., to the right) relative to the undefined reference beam index value. Time, in samples, is depicted on the horizontal axis. A key 706 is provided to correlate the patterns of the data in the spectrogram 700 to values of reference signal received power (RSRP). The neural network/AI/ML system 702 may be similar to the neural network/AI/ML system 600 as shown and described in connection with FIG. 6.

In FIG. 7, for all time presented (e.g., 0 to more than 45 samples) except for during a beam blockage event 708, the RSRP is highest for beam index values between about 29 and 31. Outside of these beam index values, that is, in the directions to the right and left of the transmit antenna beams associated with beam index values between about 29 and 31, the RSRP varies between about 0.25 and 0.1 (e.g., milliwatts, dBm, another measure of power, or a value proportionate to a measure of power). The variations in power levels from about 0 samples to 10 samples remain approximately constant for each of the antenna beams associated with the beam index values between about 0-12 and 34-70.

The variations in power levels in time from about 10 samples to 19 samples remain approximately constant for each of the antenna beams associated with beam index values between about 0-10 and 32-70. However, within the period from about 10 to 19 samples, the RSRP values among antenna beam index values of 11-28 are perturbed; they are no longer constant or substantially constant for each beam index value. Instead, for each beam index value within the period from about 10 to 19 samples, the RSRP value associated with each of the beam index values 11-28 range from about 0.4 to 0.1.

From about 19 samples to about 36 samples, the RSRP associated with all beam index values 0-70 drops to less than or equal to 0.05. The period between about 19-36 samples may be referred to as a beam blockage event 708. In the example, a man-made or natural object may have interrupted the line-of-sight of the transmit and receive beam pair links utilized between the UE and the network node. In some examples, the beam blockage event 708 may be due, for example, to a bus, truck, automobile, motorcycle, bicycle, pedestrian, or object carried by the pedestrian or even a user's own body becoming interposed between the UE and the network node. In some examples, the beam blockage event 708 may be due, for example, the trajectory or geographic path taken by the UE, where the trajectory or geographic path results in a man-made or natural object, such as a building, a wall, a basement, a tunnel, a mountain, a canyon, etc. becoming interposed between the UE and the network node. The preceding lists are exemplary and non-limiting.

In each example, regardless of what caused the beam blockage event 708, the blockage was temporary in nature. That is, the beam blockage event 708 lasted for a finite number of samples in the time domain. Evidence of the temporary nature of the exemplified blockage 798 event may be found in the spectrogram 700 during the period between about 36 and 46 samples and across all beam index values. In that period, and across all beam index values, the RSRP values return to or substantially return to the values and distributions that were observed between 0 and about 9 samples.

It is noted that the beam blockage event 708 was preceded by the perturbations of the measured RSRP values associated with antenna beam index values of 11-28 within the period from about 10 to 19 samples. According to aspects herein, those perturbations may be referred to as a “wireless signature” (also referred to herein as “pre-blockage signature” 710). It is further noted that the pre-blockage signature 710 associated with a cause of a given beam blockage event 708 may be similar to other pre-blockage signatures (not shown) of other blockage events (not shown) having similar causes. For example, without regard to the geographic location on Earth, or the relative orientation (e.g., North, South, East, West) of the UE to the base station, a truck (e.g., a tractor-trailer combination having a standard size cargo container) approaching a UE (e.g., either a vehicle itself or a passenger having the UE in the vehicle) from the left and crossing in front of the UE thereby blocking the line-of-sight between the UE and an associated base station, may have relatively the same pre-blockage signature 710 as a comparable truck (e.g., a comparable tractor-trailer combination having a comparable standard size cargo container) at some other geographic location crossing in front of a comparable UE and similarly blocking the line-of sight between the comparable UE and its associated comparable base station.

Certain criteria for prediction of a beam failure may be established according to some aspects described herein. For example, an existing beam failure detection event, such as an event that causes a UE in a connected mode (such as the connected mode 404 as shown and described in connection with FIG. 4) to begin a beam failure recovery process (such as the beam failure recovery procedure 406 process as shown and described in connection with FIG. 4) may be a reactive procedure that may be defined in a specification and followed by manufacturers of UEs. In one example, the specification may state that a UE is to compare a PDCCH block error rate (BLER) for a beam failure detection reference signal (BFD-RS) with a first threshold (to detect a beam failure instance) over a given period and compare a number of beam failure instances with a second threshold. BLER is a physical-layer error estimation technique in which involves obtaining a ratio of a number of transport blocks received in error to the total number of blocks transmitted over a certain number of frames.

However, to proactively predict a beam failure event, the process mentioned above and defined in the specification may not be sufficient. In general, a thresholding criterion test/evaluation (such as the aforementioned BLER BFD-RS process) may not be sufficient to predict a blockage event, such as the beam blockage event 708 illustrated in FIG. 7.

Instead, as described herein, a base station may configure a set of reference signals, similar to existing BFD-RSs but different from the existing BFD-RSs. The set of reference signals may be referred to herein as beam blockage prediction-reference signals. According to some aspects, the base station may conduct a beam sweep using the beam blockage prediction-reference signals. The beam blockage prediction-reference signals may be enabled through CSI-RS configuration by the base station. In one example, the beam blockage prediction-reference signals may be enabled through CSI-RS resource configuration that may enable sweeping over a number of beams. In another example, CSI-RS with repetition (for beam blockage prediction-reference signals) may be configured, so that a UE could make measurements using different receive beams and create a spectrogram from those measurements over time. For either transmit beam sweeping or receive beam sweeping, the wireless communication device may obtain a pattern created over time (e.g., a spectrogram) that may be used for blockage prediction. As described above, an imminent blockage event, such as a beam blockage event 708, may produce a variation (a perturbation) in the beam blockage prediction-reference signal RSRP measurements across beams and across time. This variation may be identified as a wireless signature or a pre-blockage signature, such as the pre-blockage signature 710. However, such pre-blockage signatures may be difficult to detect and decipher. According to aspects described herein, a neural network/AI/ML system (e.g., the neural network/AI/ML system 600 as shown and described in connection with FIG. 6) may be trained to learn blockage prediction tasks based on the identification of pre-blockage signatures, for example.

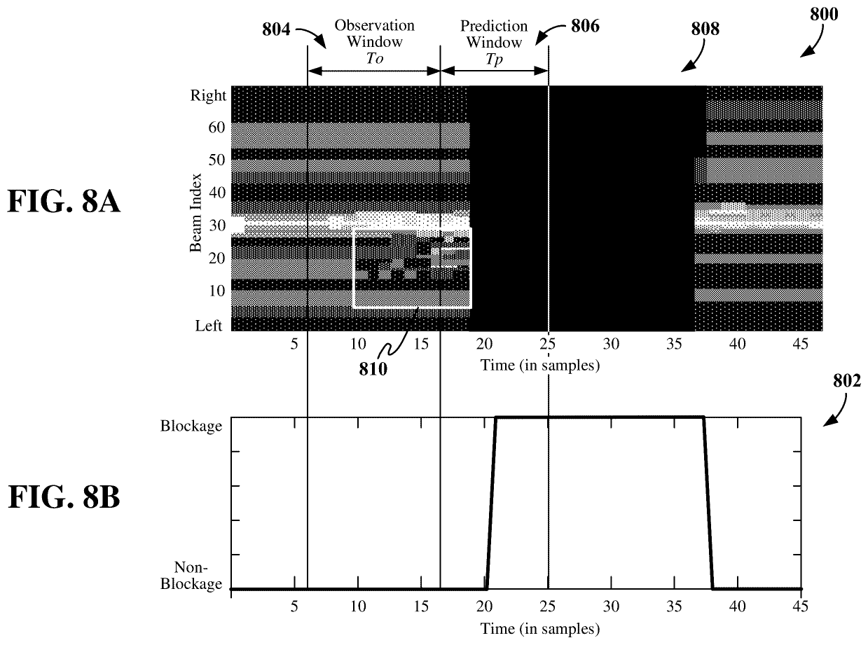

FIGS. 8A and 8B are, respectively, a spectrogram 800 that depicts beam index versus time as a function of reference signal received power, and a graph 802 indicating beam blockage, or an absence of beam-blockage (i.e., non-blockage) versus time, according to one example provided in the disclosure. The time scales of FIGS. 8A and 8B coincide (i.e., the time axis of FIGS. 8A and 8B correspond to or overlap with each other).

The spectrogram 800 of FIG. 8A may be similar to the spectrogram 700 as shown and described in connection with FIG. 7. Accordingly, a detailed description of the spectrogram 800 will be omitted for the sake of brevity. Generally, however, the spectrogram 800 includes a beam blockage event 808 (similar to beam blockage event 708 as shown and described in connection with FIG. 7) and a pre-blockage signature 810 (similar to the pre-blockage signature 710 as shown and described in connection with FIG. 7). In FIG. 8, the perturbations of the RSRP measurements of the beam blockage prediction-reference signals across beams and across time (e.g., the pre-blockage signature 810) are surrounded by a box to highlight and readily identify the perturbations.

A pair of time windows are introduced in connection with FIGS. 8A and 8B. A first time window may be referred to as an observation window 804. The observation window 804 has a duration denoted as To. The observation window 804 may represent the duration, To, over which a neural network/AI/ML circuit of a UE may monitor for pre-blockage signatures (such as pre-blockage signature 810). The monitoring for pre-blockage signatures may include monitoring RSRP measurements of respective beam blockage prediction-reference signal variations across beams and across time (e.g., across the duration To). A UE may monitor the RSRP of the respective beam blockage prediction-reference signals across beams and across time during the observation window 804. By way of example, the UE may provide this data, for example, as training data 610, to a model training 604 circuit/function as shown and described in connection with FIG. 6.

A second time window may be referred to as a prediction window 806. The prediction window 806 has a duration denoted as Tp. The prediction window 806 may represent that duration (e.g., that period), Tp, during which the AI/ML module may perform predictions related to beam failure events. As depicted in the example of FIG. 8B, a change of state, from non-blockage to blockage may occur during the prediction window 806.

According to some aspects herein, a base station may configure a statistical metric as a criterion for blockage event prediction. A UE may perform measurements during the observation window 804. The UE may predict information related to a blockage event that may occur during the prediction window 806 using, for example, the statistical metric. Statistical properties (e.g., mean, standard deviation, variance, etc.) of the RSRP measurements of the respective beam blockage prediction-reference signal across beams and across time may assist in locating/detecting/identifying pre-blockage signatures, such as pre-blockage signature 810. As an example, the criterion set forth by the base station may be in the form of variance (e.g., a statistical property) of RSRP measurements of the respective beam blockage prediction-reference signals across beams and across time during an observation window. According to some aspects, the length of the observation window may be configured by the base station and/or suggested by the UE.

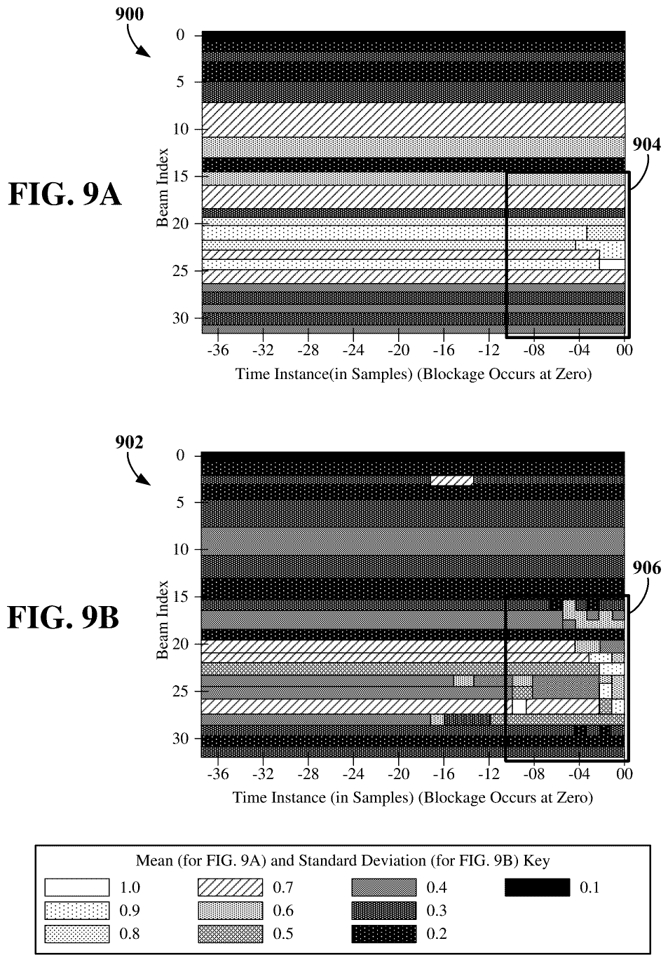

FIG. 9A is a first spectrogram 900 of mean values of RSRP of the beam blockage prediction-reference signals over beams and over time according to one example provided in the disclosure. FIG. 9B is a second spectrogram 902 of a standard deviation of the RSRP of the beam blockage prediction-reference signals of FIG. 9A over the same beams and over the same time as depicted in the example of FIG. 9A. In both FIGS. 9A and 9B beam index values are presented on the vertical axis and time (in samples) is presented on the horizontal axis. The time of the blockage event (i.e., the onset of an occurrence of a blockage event) is zero. Time is presented in negative values to represent the time before the blockage event. The vertical and the horizontal axis of FIGS. 9A and 9B coincide; that is, FIGS. 9A and 9B depict the same set of base index values (0-35) over the same time (minus 36-0).

The mean values presented in FIG. 9A, and the standard deviation values shown in FIG. 9B may both be considered as statistical metrics herein. In general, and as observed from the examples of FIGS. 9A and 9B, the variance of the mean values in the first area 906 of FIG. 9A is less than the variance of the standard deviation values in the corresponding area 908 of FIG. 9B. That is, there are fewer perturbations of the mean values in the first area 906 than of the standard deviation values in the corresponding area 908. Additionally, in both FIGS. 9A and 9B, the variance of (of the mean values and standard deviation values) of the reference signal received power increase as the time grows closer to a blockage event; that is, as time grows closer to 0 (the onset of the blockage event). It is noted that the mean is the average of a set of values, the standard deviation is the spread of a group of numbers from the mean, and the variance measures the average degree to which each point differs from the mean. While standard deviation is the square root of the variance, variance is the average of all data points within a group.

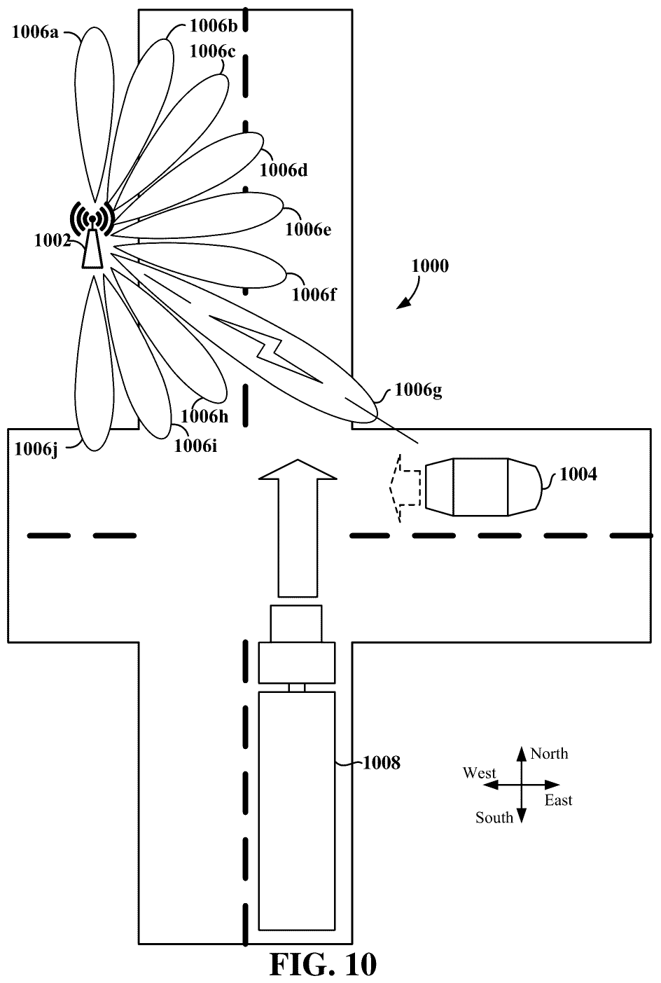

FIG. 10 is an aerial view of a traffic intersection 1000 according to some aspects of the disclosure. A base station 1002 is depicted in the distance to the North-West of a vehicle/UE 1004. The vehicle/UE 1004 is stopped at the traffic intersection 1000. For ease of explanation and illustrative purposes, the vehicle/UE 1004 may itself be considered a UE, or a wireless communication device held by a passenger within the vehicle may be the UE. The vehicle/UE 1004 may intend to move forward once traffic is no longer anticipated to cross the traffic intersection 1000 (as indicated by the dashed arrow in front of the vehicle/UE 1004). The base station 1002 and the vehicle/UE 1004 are in a connected mode. A directional transmit antenna beam 1006g serves the vehicle/UE 1004. A corresponding receive beam from the vehicle/UE 1004 is not illustrated to avoid cluttering the drawing. The directional transmit antenna beam 1006g is one of a plurality of directional transmit antenna beams 1006a-1006j. The plurality of directional antenna beams 1006a-1006j may operate in the mmWave band. Accordingly, each of the plurality of directional transmit antenna beams 1006a-1006j may be affected by objects (natural or man-made) blocking the line-of-sight between the base station 1002 and a UE, such as the vehicle/UE 1004 of FIG. 10.

FIG. 10 also depicts a tractor-trailer hauling a standard size cargo container (collectively, the tractor-trailer 1008). The tractor-trailer 1008 is proceeding across the intersection, as depicted by the solid arrow illustrated at the front of the tractor-trailer 1008. At the instant shown in FIG. 10, the tractor-trailer 1008 does not block the line-of-sight between the base station 1002 and the vehicle/UE 1004. Accordingly, a two-way radio link between the base station 1002 and the vehicle/UE 1004 is maintained via the directional transmit antenna beam 1006g (and a corresponding receive antenna beam, not shown, of the vehicle/UE 1004).

The base station 1002 may cause a beam sweep to occur. The beam sweep may transmit a plurality of beam blockage prediction-reference signals, each associated with a respective beam index value (e.g., a beam identifier), via respective ones of the plurality of directional transmit antenna beams 1006a-1006j.

The vehicle/UE 1004 may measure and collect the RSRPs of the beam blockage prediction-reference signals across the beams and across time. The vehicle/UE 1004 may obtain (e.g., generate, derive, format, prepare) a spectrogram (e.g., similar to the spectrogram 700, 800, 900, and/or 902 as shown and described in connection with FIGs. 7, 8A, 9A, and/or 9B, respectively). Similarly to FIGS. 7, 8A, 9A, and/or 9B, the power of the RSRP of the beam failure prediction-reference beams in FIGS. 7 and 8A, the mean value of the RSRP in FIG. 9A, and/or the standard deviation of the RSRPs in FIG. 9B may remain constant, or substantially constant in the time samples before the tractor-trailer 1008 advances into the traffic intersection 1000. By way of example, beam index 30 of FIGS. 7 and 8A may correspond to directional antenna beam 1006g of FIG. 10. Accordingly, the RSRP of beam index 29-31 in FIGS. 7 and 8A may be higher than all other RSRPs associated with all other directional antenna beams.

However, and as illustrated in FIGS. 7, 8A, 9A, and/or 9B the power of the RSRP of the beam blockage prediction-reference signals across beams and across times in FIGS. 7A and 8A, and the mean of the RSRP in FIG. 9A, and/or the standard deviation of the RSRP in FIG. 9B, become increasingly perturbed during the ten time samples prior to when the body of the tractor-trailer 1008 completely enters the traffic intersection 1000 and blocks the line-of-sight between the base station 1002 and the vehicle/UE 1004. The perturbations in the ten time samples preceding the onset of the blockage event (e.g., beam blockage event 708 of FIG. 7, 808 of FIG. 8A, and the onset of the blockage event at time instance zero in FIGS. 9A and 9B) may represent the start of the pre-blockage signature 710 of FIGS. 7 and 810 of FIG. 8A, 904 of FIG. 9A, and 906 of FIG. 9B of the tractor-trailer 1008. Of course, the use of ten time samples is merely an example—pre-blockage signatures may begin more than or less than ten time samples before a given blockage event. By recognizing the pre-blockage signature, a UE measuring and collecting RSRP values of the beam blockage prediction-reference signals transmitted in the beam sweep from any given base station may be able to predict an occurrence of a similar blockage event, a time of onset of the similar blockage event, a severity (e.g., in terms of duration) of the similar blockage event, and a bearing of an object corresponding to the similar beam blockage event (in the example of FIG. 10, the blockage event travels from left to right across the front of the vehicle/UE 1004).

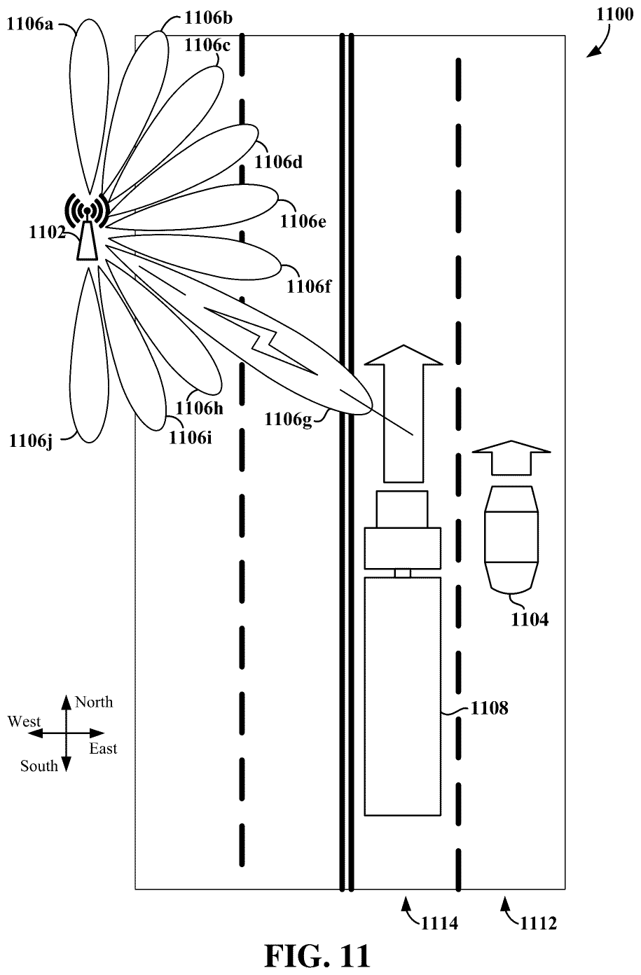

FIG. 11 is an aerial view of a portion of a four-lane divided highway 1100 according to some aspects of the disclosure. A base station 1102 is depicted in the distance to the North-West of a vehicle/UE 1104. The vehicle/UE 1104 is proceeding in a Northernly direction in a right lane 1112 of the Northbound portion of the four-lane divided highway 1100. For ease of explanation and for illustrative purposes, the vehicle/UE 1104 may itself be considered a UE, or a wireless communication device held by a passenger within the vehicle may be the UE. The speed of the vehicle/UE 1004 is represented by the length of the solid arrow ahead of the vehicle/UE 1104. The base station 1102 and the vehicle/UE 1104 are in a connected mode. A directional transmit antenna beam 1106g serves the vehicle/UE 1104. A corresponding receive beam from the vehicle/UE 1104 is not illustrated to avoid cluttering the drawing. The directional transmit antenna beam 1106g is one of a plurality of directional transmit antenna beams 1106a-1106j. The plurality of directional transmit antenna beams 1106a-1106j may operate in the mmWave band. Accordingly, each of the plurality of directional transmit antenna beams 1106a-1106j may be affected by objects (natural or man-made) blocking the line-of-sight between the base station 1102 and a UE, such as the vehicle/UE 1104 of FIG. 11.

FIG. 11 also depicts a tractor-trailer hauling a standard size cargo container (collectively, the tractor-trailer 1108). The tractor-trailer 1108 is also proceeding in a Northernly direction, but in a left lane 1115 of the Northbound portion of the four-lane divided highway 1100. The speed of the tractor-trailer 1008 is represented by the length of the arrow preceding the tractor-trailer 1008. At the instant shown in FIG. 11, the tractor-trailer 1108 is even with the vehicle/UE 1104 but is accelerating to pass the vehicle/UE 1104 (as shown by the representative difference between the lengths of the respective arrows (e.g., the magnitudes of the respective speeds) that precede the tractor-trailer 1108 and the vehicle/UE 1004). At the instant shown in FIG. 11, the body of the tractor-trailer 1108 does not block the line-of-sight between the base station 1102 and the vehicle/UE 1104. Accordingly, a two-way radio link between the base station 1102 and the vehicle/UE 1104 is maintained via the directional transmit antenna beam 1106g (and a corresponding receive antenna beam, not shown, of the vehicle/UE 1104).

The base station 1102 may cause a beam sweep to occur. The beam sweep may transmit a plurality of beam blockage prediction-reference signals, each associated with a respective beam index value (e.g., a beam identifier), via respective ones of the plurality of directional transmit antenna beams 1106a-1006j.

The vehicle/UE 1104 may measure and collect the RSRPs of the beam blockage prediction-reference signals over the beams and over time. The vehicle/UE 1104 may obtain (e.g., generate, derive, format, prepare) a spectrogram, similar to the spectrogram 700 and/or the spectrogram 800 as shown and described in connection with FIGS. 7 and 8A, respectively. Similar to FIGS. 7 and 8A, the RSRP of the beam failure prediction-reference beams may remain constant or substantially constant in the time samples before the tractor-trailer 1108 overtakes the vehicle/UE 1104. By way of example, beam index 30 of FIGS. 7 and 8A may correspond to directional antenna beam 1106g of FIG. 11. Accordingly, the RSRP of beam index 29-31 may be higher than all other RSRPs associated with all other directional antenna beams.

However, and as illustrated in FIGS. 7 and 8A (and using the time scale of FIGS. 7 and 8A for illustrative and non-limiting purposes), the RSRP of the beam blockage prediction-reference signals across beams and across times becomes increasingly perturbed during the ten time samples prior to when the body of the tractor-trailer 1108 is alongside and overtakes the vehicle/UE 1004, such that the body of the tractor-trailer 1108 blocks the line-of-sight between the base station 1102 and the vehicle/UE 1104. The perturbations in the ten time samples preceding the onset of the blockage event (e.g., beam blockage event 708 of FIGS. 7 and 808 of FIG. 8A) may represent the start of the pre-blockage signature 710 of FIGS. 7 and 810 of FIG. 8A of the tractor-trailer 1108. As before, use of the ten time samples is merely an example. Pre-blockage signatures may begin more than or less than ten time samples before a given blockage event.

By recognizing the pre-blockage signature, a UE measuring and collecting RSRP values of the beam blockage prediction-reference signals transmitted in the beam sweep from any given base station may be able to predict an occurrence of a similar blockage event, a time of onset of the similar blockage event, a severity (e.g., in terms of duration) of the similar blockage event, and a bearing of an object corresponding to the similar beam blockage event (in the example of FIG. 11, the blockage event travels from the rear toward the front of, and alongside the left half of, the vehicle/UE 1104).

According to one aspect, determining and reporting a potential (future) blockage event may include having a UE configured to compare a statistical metric configured by the base station (e.g., the variance) with a threshold. If the statistical metric is larger than a threshold for more than a given number of times (e.g., for more than a given number of time samples), the UE may report information related to a predicted blockage event.

Based on whether (or not) the UE observes and reports a beam blockage event (e.g., after realizing an actual beam blockage event corresponding to the predicted blockage event), the base station may adjust the value of statistical metric.

The statistical metric, the time duration for observation window, the number of consecutive times (time samples) that the configured criterion is not satisfied, etc. may be configured through RRC messaging, for example. In one example, the criterion set forth by the base station may be in the form of PDCCH-BLER variations across beam blockage prediction-reference signal beams across time.

According to another aspect, a base station may configure a UE with beam blockage prediction-reference signals and may also configure a format for outputs of a neural network (e.g., similar to the neural network/AI/ML system 600 of FIG. 6). The machine learning feature according to this aspect may be included in the implementation of the UE. For example, the UE may label the outputs of the neural network following an existing procedure for beam failure detection and recovery. In some examples, this aspect may be implemented as a signal processing aspect implemented at the UE, instead of a neural network, for example.

According to another aspect, the base station may share a blockage prediction neural network with a plurality of UEs. Each UE may monitor for beam blockage prediction-reference signals and label the output of the neural network as instructed by the base station. The blockage prediction neural network may be trained in a federated learning context. In other words, the neural network may be trained using data from the plurality of UEs (i.e., from a federation of UEs). According to such an aspect, the UEs may obtain a series of spectrograms along with their corresponding labels.

According to the aspect related to a federated learning context, the blockage prediction neural network may be shared with sets of UEs that experience similar monitored measurements. The federated learning context may benefit from this organization because different sets of UEs (i.e., different member UEs of the federation) may experience a greater number of blockage events than a single UE or a single set of UEs. Furthermore, a plurality of UEs and/or a plurality of sets of UEs may have a quantity of realized blockage events (e.g., actual blockage events) that may be used to train the neural network.

By way of example, in a training phase, a base station may share a blockage prediction neural network with a set of similar UEs. The base station may notify the set of similar UEs upon reaching a convergence based on a use of a federated learning process. Upon convergence, the neural network may be considered a trained neural network. The set of similar UEs may then use the trained neural networks in an inference phase. In other words, instead of defining a criterion (e.g., a statistical criterion), the base station may configure the UEs with the neural network, and the output of the neural network may provide the blockage prediction task, as opposed to an explicit metric or criterion.

According to another aspect, in all of the aspects described above, a determination of information about a blockage event (e.g., information related to the blockage event) may be made at the UE side and the result of the determination (e.g., predictions of blockage events) may be reported to base station. An alternate approach may be that the base station may configure a UE to report statistics of beam measurements (across beams and across time), and a feature vector (that may be generated through a machine language module).

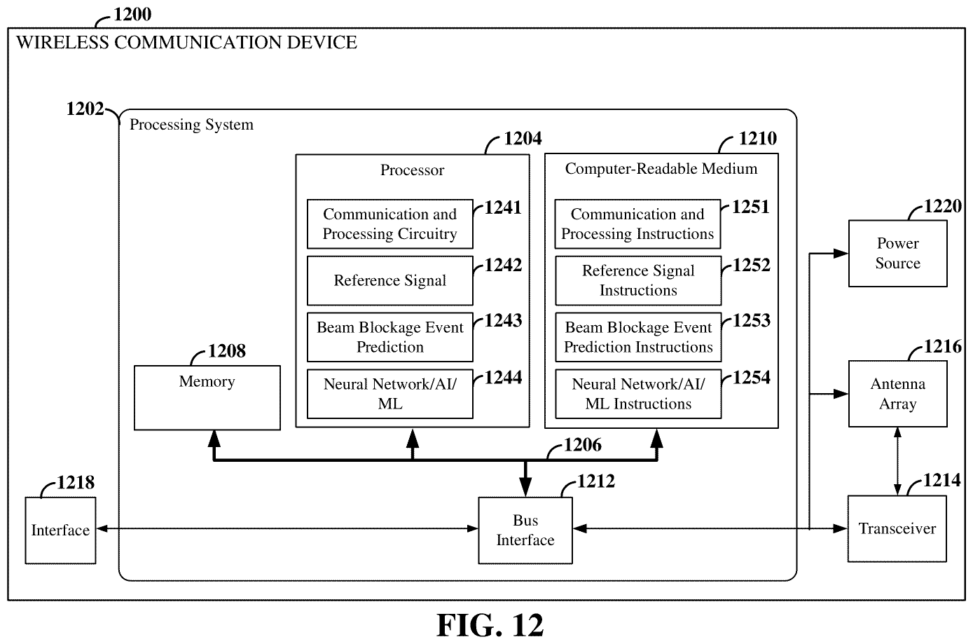

FIG. 12 is a block diagram illustrating an example of a hardware implementation of a wireless communication device 1200 employing a processing system 1202 according to some aspects of the disclosure. The wireless communication device 1200 may be a scheduled entity (e.g., a UE) as illustrated in any one or more of FIGS. 1, 2, 5A, 5B, 5C, 10, and/or 11.

In accordance with various aspects of the disclosure, an element, or any portion of an element, or any combination of elements may be implemented with a processing system 1202 that includes one or more processors, such as processor 1204. Examples of processors 1204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 1200 may be configured to perform any one or more of the functions described herein. That is, the processor 1204, as utilized in the wireless communication device 1200, may be used to implement any one or more of the methods or processes shown and described, for example, in any one or more of FIGS. 4 and/or 6.

The processor 1204 may, in some examples, be implemented via a baseband or modem chip and in other implementations, the processor 1204 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

The processor 1204 may be configured to receive a first signal and transmit a second signal. In some aspects, reference to the processor being configured to receive the first signal may refer to the processor being configured to obtain first information corresponding to the first signal. For example, the first information may be demodulated information, decoded information, or any information corresponding to the first signal.

As another example, the first information may refer to information output from a receiver, transceiver, RF circuitry, or the like that resides between the processor and an antenna. In some aspects, reference to the processor being configured to transmit the second signal may refer to the processor being configured to cause transmission of the second signal. For example, to cause transmission of the second signal, the processor may be configured to cause a transmitter, transceiver, RF circuitry, or the like to transmit the second signal.

The processing system 1202 may be implemented with a bus architecture, represented generally by the bus 1206. The bus 1206 may include any number of interconnecting buses and bridges depending on the specific application of the processing system 1202 and the overall design constraints. The bus 1206 communicatively couples together various circuits, including one or more processors (represented generally by the processor 1204), a memory 1208, and computer-readable media (represented generally by the computer-readable medium 1210). The bus 1206 may also link various other circuits such as timing sources, peripherals, voltage regulators, and power management circuits, which are well known in the art, and, therefore, will not be described any further.

A bus interface 1212 provides an interface between the bus 1206 and a transceiver 1214. The transceiver 1214 may be a wireless transceiver. The transceiver 1214 may provide a means for communicating with various other apparatus over a transmission medium (e.g., air interface). The transceiver 1214 may further be coupled to one or more antenna arrays (hereinafter antenna array 1216). The bus interface 1212 further provides an interface between the bus 1206 and a user interface 1218 (e.g., keypad, display, touch screen, speaker, microphone, control features, etc.). Of course, such a user interface 1218 is optional and may be omitted in some examples. In addition, the bus interface 1212 further provides an interface between the bus 1206 and a power source 1220 of the wireless communication device 1200.

The processor 1204 is responsible for managing the bus 1206 and general processing, including the execution of software stored on the computer-readable medium 1210. The software, when executed by the processor 1204, causes the processing system 1202 to perform the various functions described below for any particular apparatus. The computer-readable medium 1210 and the memory 1208 may also be used for storing data that is manipulated by the processor 1204 when executing software.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1210. When executed by the processor 1204, the software may cause the processing system 1202 to perform the various processes and functions described herein for any particular apparatus.

The computer-readable medium 1210 may be a non-transitory computer-readable medium and may be referred to as a computer-readable storage medium or a non-transitory computer-readable medium. The non-transitory computer-readable medium may store computer-executable code (e.g., processor-executable code). The computer-executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1210 may reside in the processing system 1202, external to the processing system 1202, or distributed across multiple entities including the processing system 1202. The computer-readable medium 1210 may be embodied in a computer program product or article of manufacture. By way of example, a computer program product or article of manufacture may include a computer-readable medium in packaging materials. In some examples, the computer-readable medium 1210 may be part of the memory 1208. Those skilled in the art will recognize how best to implement the described functionality presented throughout this disclosure depending on the particular application and the overall design constraints imposed on the overall system.

In some aspects of the disclosure, the processor 1204 may include communication and processing circuitry 1241 configured for various functions, including, for example, communicating with other wireless communication devices (e.g., a scheduling entity, a scheduled entity), a network core (e.g., a 5G core network), or any other entity, such as, for example, local infrastructure or an entity communicating with the wireless communication device 1200 via the Internet, such as a network provider. In some examples, the communication and processing circuitry 1241 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1241 may include one or more transmit/receive chains.

In some implementations where the communication involves receiving information, the communication and processing circuitry 1241 may obtain or identify information from a component of the wireless communication device 1200 (e.g., from the transceiver 1214 that receives the information via radio frequency signaling or some other type of signaling suitable for the applicable communication medium), process (e.g., decode) the information, and output the processed information. For example, the communication and processing circuitry 1241 may output the information to another component of the processor 1204, to the memory 1208, or to the bus interface 1212. In some examples, the communication and processing circuitry 1241 may receive one or more of: signals, messages, other information, or any combination thereof. In some examples, the communication and processing circuitry 1241 may receive information via one or more channels. In some examples, the communication and processing circuitry 1241 may include functionality for a means for receiving. In some examples, the communication and processing circuitry 1241 may include functionality for a means for processing, including a means for demodulating, a means for decoding, etc.

In some implementations where the communication involves sending (e.g., transmitting) information, the communication and processing circuitry 1241 may obtain or identify information (e.g., from another component of the processor 1204, the memory 1208, or the bus interface 1212), process (e.g., modulate, encode, etc.) the information, and output the processed information. For example, the communication and processing circuitry 1241 may obtain data stored in the memory 1208 and may process the obtained data according to some aspects of the disclosure.

In some examples, the communication and processing circuitry 1241 may obtain information and output the information to the transceiver 1214 (e.g., transmitting the information via radio frequency signaling or some other type of signaling suitable for the applicable communication medium). In some examples, the communication and processing circuitry 1241 may send one or more of signals, messages, other information, or any combination thereof. In some examples, the communication and processing circuitry 1241 may send information via one or more channels. In some examples, the communication and processing circuitry 1241 may include functionality for a means for sending (e.g., a means for transmitting). In some examples, the communication and processing circuitry 1241 may include functionality for a means for generating, including a means for modulating, a means for encoding, etc. In some examples, the communication and processing circuitry 1241 may be configured to receive and process uplink traffic and uplink control messages (e.g., similar to uplink traffic 126 and uplink control 128 of FIG. 1) and process and transmit downlink traffic and downlink control messages (e.g., similar to downlink traffic 122 and downlink control 124 of FIG. 1) via the antenna array 1216 and the transceiver 1214.

The communication and processing circuitry 1241 may further be configured to execute communication and processing instructions 1251 (e.g., software) stored on the computer-readable medium 1210 to implement one or more functions described herein.

In some aspects of the disclosure, the processor 1204 may include reference signal circuitry 1242. The reference signal circuitry 1242 may be configured for various functions, including, for example, receiving a plurality of reference signals, where each of the plurality of reference signals corresponds to a respective identifier of a plurality of identifiers. According to some aspects, the plurality of reference signals may include beam blockage prediction-reference signals. By way of example and without limitation and as described above, in some examples beam blockage prediction-reference signals may be different from BFD-RSs. The reference signal circuitry 1242 may be configured to execute reference signal instructions 1252 (e.g., software) stored on the computer-readable medium 1210 to implement one or more functions described herein.

In some aspects of the disclosure, the processor 1204 may include beam blockage event prediction circuitry 1243. The beam blockage event prediction circuitry 1243 may be configured for various functions, including, for example, transmitting prediction information indicative of a predicted beam blockage event, where the prediction information may be based on measurement information corresponding to the plurality of reference signals during a time period. According to some aspects, the beam blockage event prediction circuitry 1243 may obtain the measurement information during the time period. The time period may be referred to herein as an observation window, such as the observation window 804, as shown and described in connection with FIGS. 8A and 8B. In some examples, to obtain the measurement information during the time period, the processor 1204 may be configured to perform one or more measurements during the time period to generate the measurement information. According to some aspects, the measurement information may include respective reference signal received power (RSRP) information for each respective reference signal of the plurality of reference signals.

According to some aspects, the beam blockage event prediction circuitry 1243 may be configured for various additional functions, including, for example, receiving prediction configuration information, where the prediction configuration information may include information indicative of at least one of: a length of the time period, a statistical metric used to predict the predicted beam blockage event, a threshold value that may be compared to the statistical metric, an occurrence of the predicted beam blockage event, an instance of the predicted beam blockage event, a severity of the predicted beam blockage event, or a bearing of an object corresponding to the predicted beam blockage event. In some examples, the measurement information may be based on the prediction configuration information. In some examples, the prediction information may be based on the prediction configuration information. In some examples, the measurement information may include a plurality of reference signal received power measurements corresponding to a respective plurality of beam identification values as a function of time, where the processor 1204 may be configured to compare the statistical metric associated with the plurality of reference signal received power measurements to the threshold value, and where, to transmit the prediction information, the processor 1204 may be configured to transmit the prediction information based on the comparison.

The beam blockage event prediction circuitry 1243 may be configured to execute beam blockage event prediction instructions 1253 (e.g., software) stored on the computer-readable medium 1210 to implement one or more functions described herein.

In some aspects of the disclosure, the processor 1204 may include neural network/artificial intelligence (AI)/machine learning (ML) circuitry 1244. Some parts or all of the neural network/AI/ML circuitry 1244 may be optional. The neural network/AI/ML circuitry 1244 may be configured for various functions, including, for example, providing the measurement information to a model, and obtaining, as an output from the model, the prediction information. In some examples, the neural network/AI/ML circuitry 1244, may be configured to receive, from a second network node, the model or information indicative of the model. In such examples, the second network node may be a base station (e.g., a network access node, a scheduling entity, a gNB). According to some aspects, the model may include a neural network. According to some aspects, neural network training of the neural network may utilize a plurality of spectrograms from at least one of the first network node and/or a plurality of other network nodes. Each of the plurality of spectrograms may comprise a respective set of respective beam measurements of each respective reference signal associated with each respective beam identifier as the function of time. Of course, the respective set of respective beam measurements of each respective reference signal associated with each respective beam identifier as the function of time need not be provided in the form of a spectrogram. For example, rather than formatting the data into a spectrogram format, the neural network may receive the respective set of respective beam measurements of each respective reference signal associated with each respective beam identifier as the function of time directly. According to some aspects, to provide the measurement information to the model, the neural network/AI/ML circuitry 1244, may be configured to transmit the measurement information to a second network node. In this as in a preceding example, the second network node may be a base station (e.g., a network access node, a scheduling entity, a gNB).

According to some aspects, the prediction information indicative of the predicted beam blockage event may include at least one of: information indicative of an instance of the predicted beam blockage event, information indicative of a severity of the predicted beam blockage event, or information indicative of a bearing of an object corresponding to the predicted beam blockage event. In some examples, the information indicative of the instance of the predicted beam blockage event may correspond to a prediction of a start of the predicted beam blockage event in the time domain. In some examples, the information indicative of the severity of the predicted beam block may correspond to a duration of the predicted beam blockage event. In some examples, the information indicative of the bearing of an object corresponding to the predicted beam blockage event may include information indicative motion relative to the first network node.

The neural network/AI/ML circuitry 1244 may be configured to execute neural network/AI/ML instructions 1254 (e.g., software) stored on the computer-readable medium 1210 to implement one or more functions described herein.

According to some aspects, the processor 1204, for example via the communication and processing circuitry 1241, the reference signal circuitry 1242, the beam blockage event prediction circuitry 1243, or any combination thereof, may be configured to receive prediction configuration information, where the prediction configuration information includes information indicative of a format of the prediction information, and where the prediction information complies with the format. In some examples, the prediction information indicative of the predicted beam blockage event may include information indicative of when the predicted beam blockage event is predicted to occur. In some examples, the prediction information indicative of the predicted beam blockage event may include information indicative of a duration of the predicted beam blockage event. In some examples, the prediction information indicative of the predicted beam blockage event may include information indicative of a motion direction corresponding to the predicted beam blockage event relative to the first network node.

Still further, to transmit the prediction information, the processor 1204 may be configured to transmit the prediction information based on at least one of: a time at which the predicted beam blockage event is predicted to occur, a predicted duration of the predicted beam blockage event, or a predicted motion direction corresponding to the predicted beam blockage event relative to the first network node.

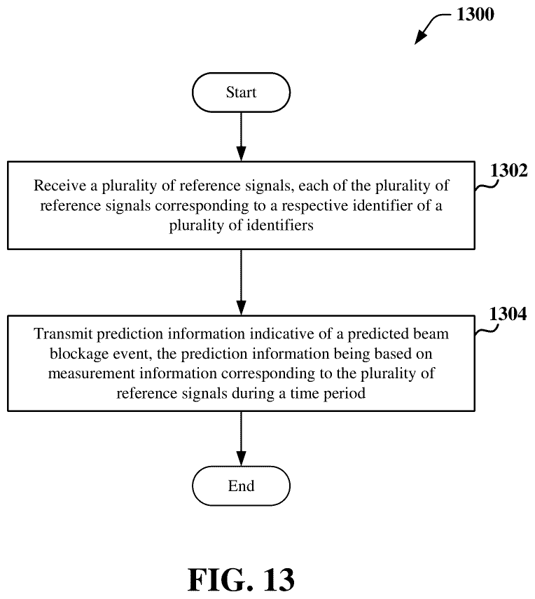

FIG. 13 is a flow chart illustrating an exemplary process 1300 (e.g., a method of wireless communication) at a wireless communication device (e.g., a scheduled entity, a user equipment (UE)) according to some aspects of the disclosure. The process 1300 may occur in a wireless communication network, such as the wireless communication networks of FIGS. 1 and/or 2, for example. As described below, some or all illustrated features may be omitted in a particular implementation within the scope of the present disclosure, and some illustrated features may not be required for all implementations. In some examples, the process 1300 may be carried out by the wireless communication device 1200 shown and described in connection with FIG. 12. In some examples, the process 1300 may be carried out by any suitable apparatus or means for carrying out the functions or algorithms described herein.

At block 1302, the wireless communication device may receive a plurality of reference signals, each of the plurality of reference signals may correspond to a respective identifier of a plurality of identifiers. For example, the reference signal circuitry 1242, in some examples in combination with the transceiver 1214 and antenna array 1216, as shown and described above in connection with FIG. 12, may provide a means for receiving a plurality of reference signals, each of the plurality of reference signals corresponding to a respective identifier of a plurality of identifiers.

As described above in connection with FIG. 12, according to some aspects, the plurality of reference signals may include a first type of one or more beam failure detection-reference signals (BFD-RSs), a second type of one or more BFD-RSs, or a combination thereof. In some examples, the first type of BFD-RSs may be BFD-RSs and the second type of BFD-RSs may be beam blockage prediction-reference signals. One example of beam blockage prediction-reference signals (e.g., reference signals used for the purpose of blockage event prediction) may be periodic CSI-RS resources configured by gNB. A wireless communication device may measure the RSRP of these periodic CSI-RS resources and may use RSRP variations of the periodic CSI-RSs across beams and across time to predict an upcoming blockage event. One distinction between BFD-RS and beam blockage prediction-reference signals may be that in order for the wireless communication device to predict a blockage event, the wireless communication device may need to measure more beams (i.e., beams transmitting BFD-RSs and/or beam blockage prediction-reference signal) than it might need to measure in connection with detecting a beam failure event. The increased number of beams may be utilized during beam blockage prediction to collect spatiotemporal variations of RSRP that together may be used to predict a given blockage event, rather than a fewer number of beams used to determine a real-time blockage event (e.g., a beam failure) which may need fewer BFD-RS beam measurements. In other words, beam blockage prediction may need a greater number of reference signals, such as BFD-RSs, beam blockage prediction-reference signals, or a combination thereof, to be configured for beam blockage prediction than the wireless communication device might use for beam failure detection. According to some aspect, the plurality of reference signals may include a plurality of beam blockage prediction-reference signals.

At block 1304, the wireless communication device may transmit prediction information indicative of a predicted beam blockage event, where the prediction information may be based on measurement information corresponding to the plurality of reference signals during a time period. For example, the beam blockage event prediction circuitry 1243, in some examples in combination with the transceiver 1214 and antenna array 1216, as shown and described in connection with FIG. 12, may provide a means for transmitting prediction information indicative of a predicted beam blockage event, where the prediction information may be based on measurement information corresponding to the plurality of reference signals during a time period.

As described above in connection with FIG. 12, according to some aspects, the method may include receiving prediction configuration information, where the prediction configuration information may include information indicative of at least one of: a length of the time period, a statistical metric used to predict the predicted beam blockage event, a threshold value that is compared to the statistical metric, an occurrence of the predicted beam blockage event, an instance of the predicted beam blockage event, a severity of the predicted beam blockage event, or a bearing of an object corresponding to the predicted beam blockage event. In some examples, the measurement information may be based on the prediction configuration information. In some examples, the prediction information may be based on the prediction configuration information. In some examples, the measurement information may include a plurality of reference signal received power measurements corresponding to a respective plurality of beam identification values as a function of time. For example, the communication and processing circuitry 1241, in some examples in combination with the transceiver 1214 and antenna array 1216, may provide the means for receiving prediction configuration information, where the prediction configuration information may include information indicative of at least one of: a length of the time period, a statistical metric used to predict the predicted beam blockage event, a threshold value that is compared to the statistical metric, an occurrence of the predicted beam blockage event, an instance of the predicted beam blockage event, a severity of the predicted beam blockage event, or a bearing of an object corresponding to the predicted beam blockage event. Still further, the method may include comparing the statistical metric associated with the plurality of reference signal received power measurements to the threshold value and transmitting the prediction information based on the comparison. For example, the beam blockage event prediction circuitry, in some examples in combination with the transceiver 1214 and antenna array 1216, may provide the means for comparing the statistical metric associated with the plurality of reference signal received power measurements to the threshold value, and transmitting the prediction information based on the comparison.

According to some aspects, the method may include providing the measurement information to a model, and obtaining, as an output from the model, the prediction information. In some examples, the method may include receiving, from a second network node, the model or information indicative of the model. In such examples, the second network node may be a base station (e.g., a network access node, a scheduling entity, a gNB). According to some aspects, the model may include a neural network. According to some aspects, neural network training of the neural network may utilize a plurality of spectrograms from at least one of the first network node and/or a plurality of other network nodes. Each of the plurality of spectrograms may comprise a respective set of respective beam measurements of each respective reference signal associated with each respective beam identifier as the function of time. Of course, as stated above, the respective set of respective beam measurements of each respective reference signal associated with each respective beam identifier as the function of time may be provided in a form other than in the form of a spectrogram. The method may also include transmitting the measurement information to the second network node. For example, the neural network/AI/ML circuitry 1244, as shown and described in connection with FIG. 12, may provide a means for providing the measurement information to a model, and obtaining, as an output from the model, the prediction information, as well as a means for receiving, from a second network node, the model or information indicative of the model.

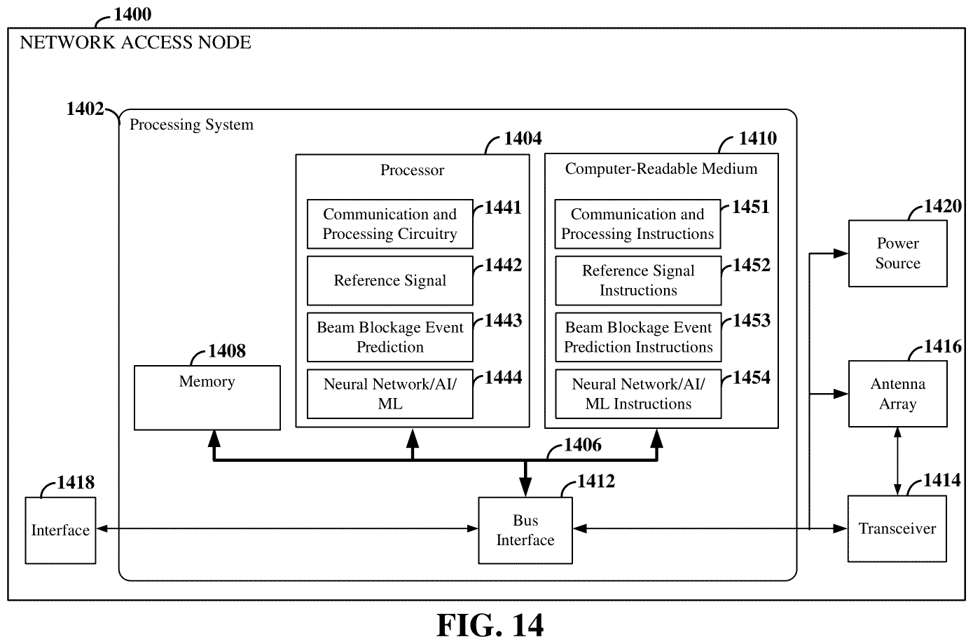

FIG. 14 is a block diagram illustrating an example of a hardware implementation of a network access node 1400 (e.g., a base station, a scheduling entity, a gNB, etc.), employing a processing system 1402 according to some aspects of the disclosure. The network access node 1400 may be, for example, any base station, scheduled entity, gNB, etc. as illustrated in any one or more of FIGS. 1, 2, 5, 10, and/or 11. In accordance with various aspects of the disclosure, an element, or any portion of an element, or any combination of elements may be implemented with a processing system 1402 that includes one or more processors, such as processor 1404. The processing system 1402 may be substantially the same as the processing system 1202 illustrated and described in connection with FIG. 12, including a bus interface 1412, a bus 1406, a memory 1408, a processor 1404, communication and processing circuitry 1441, and a computer-readable medium 1006. Furthermore, the scheduled entity 1004 may include a user interface 1012, a transceiver 1414, antenna array 1416, and power source 1420, substantially similar to those described above in connection with FIG. 12. Accordingly, their descriptions will not be repeated for the sake of brevity.

In some aspects of the disclosure, the processor 1404 may include reference signal circuitry 1442. The reference signal circuitry 1442 may be configured for various functions, including, for example, transmitting a plurality of reference signals, where each reference signal of the plurality of reference signals may correspond to a respective identifier of a plurality of identifiers. The reference signal circuitry 1242, or the communication and processing circuitry 1241, may be configured for other functions, including, for example, receiving measurement information corresponding to the plurality of reference signals during a time period. The reference signal circuitry 1442 may be configured to execute reference signal instructions 1452 (e.g., software) stored on the computer-readable medium 1410 to implement one or more functions described herein. In some aspects of the disclosure, the processor 1404 may include beam blockage event prediction circuitry 1443. The beam blockage event prediction circuitry 1443 may be configured for various functions, including, for example, transmitting prediction information indicative of a predicted beam blockage event, where the prediction information may be based on the measurement information. According to other aspects, the beam blockage event prediction circuitry 1443 may additionally or alternatively be configured to transmit prediction configuration information, where the prediction configuration information may include information indicative of at least one of: a length of the time period, a statistical metric used to predict the predicted beam blockage event, a threshold value that is compared to the statistical metric, an occurrence of the predicted beam blockage event, an instance of the predicted beam blockage event, a severity of the predicted beam blockage event, or a bearing of an object corresponding to the predicted beam blockage event. The beam blockage event prediction circuitry 1443 may be configured to execute beam blockage event prediction instructions 1453 (e.g., software) stored on the computer-readable medium 1410 to implement one or more functions described herein.

In some aspects of the disclosure, the processor 1404 may include neural network/AI/ML circuitry 1444. In some examples, the neural network/AI/ML circuitry 1444 may be optional. The neural network/AI/ML circuitry 1444 may be configured for various functions, including, for example, transmitting, to a first network node, the model or information indicative of the model. In some aspects the model includes a neural network. The neural network/AI/ML circuitry 1444 may be configured to execute neural network/AI/ML instructions 1454 (e.g., software) stored on the computer-readable medium 1410 to implement one or more functions described herein.

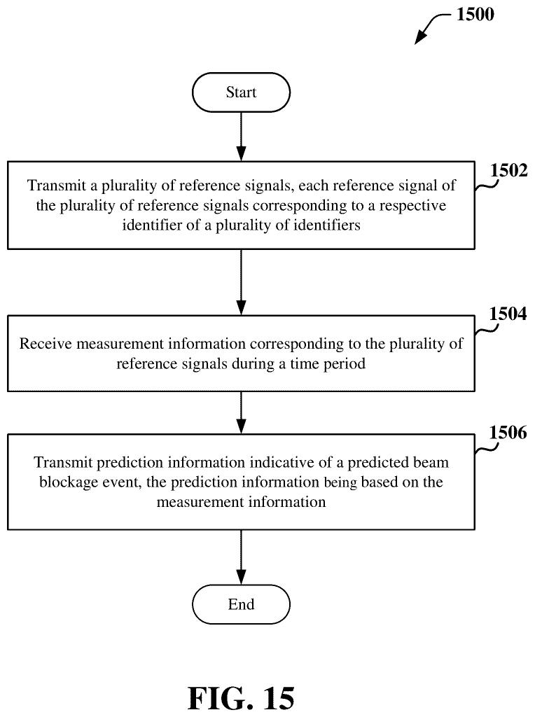

FIG. 15 is a flow chart illustrating an exemplary process 1500 (e.g., a method of wireless communication) at a network access node (e.g., a base station, a scheduling entity) according to some aspects of the disclosure. The process 1500 may occur in a wireless communication network, such as the wireless communication networks of FIGS. 1 and/or 2, for example. As described below, some or all illustrated features may be omitted in a particular implementation within the scope of the present disclosure, and some illustrated features may not be required for all implementations. In some examples, the process 1500 may be carried out by the network access node 1400 shown and described in connection with FIG. 14. In some examples, the process 1500 may be carried out by any suitable apparatus or means for carrying out the functions or algorithms described herein.

At block 1502, the network access node may transmit a plurality of reference signals, wherein each reference signal of the plurality of reference signals corresponds to a respective identifier of a plurality of identifiers. For example, the reference signal circuitry 1442, in some examples in combination with the transceiver 1414 and antenna array 1416, all as shown and described in connection with FIG. 14, may provide a means for transmitting a plurality of reference signals, wherein each reference signal of the plurality of reference signals corresponds to a respective identifier of a plurality of identifiers.

At block 1504, the network access node may receive measurement information corresponding to the plurality of reference signals during a time period. For example, the reference signal circuitry 1442, in some examples in combination with the transceiver 1414 and antenna array 1416, all as shown and described in connection with FIG. 14, may provide a means for receiving measurement information corresponding to the plurality of reference signals during a time period.

At block 1506, the network access node may transmit prediction information indicative of a predicted beam blockage event, where the prediction information may be based on the measurement information. For example, the beam blockage event prediction circuitry 1443, in some examples in combination with the transceiver 1414 and antenna array 1416, all as shown and described in connection with FIG. 14, may provide a means for transmitting prediction information indicative of a predicted beam blockage event, where the prediction information may be based on the measurement information.

According to some aspects, the network access node may be configured to transmit, to a second network node, a model or information indicative of the model. In some examples, the model includes a neural network. For example, the neural network/AI/ML circuitry 1444, in some examples in combination with the transceiver 1414 and antenna array 1416, all as shown and described in connection with FIG. 14, may provide a means for transmitting, to a second network node, a model or information indicative of the model. According to some examples, the second network node may be a user equipment. The second network node may be a UE in some examples.

Of course, in the above examples, the circuitry included in the processor 1204 as shown and described in connection with FIG. 12, and processor 1404 as shown and described in connection with FIG. 14, are merely provided as examples. Other means for carrying out the described processes or functions may be included within various aspects of the present disclosure, including but not limited to the instructions stored in the computer-readable medium, such as computer-readable medium 1210 of FIG. 12 and/or computer-readable medium 1410 of FIG. 14, or any other suitable apparatus or means described in any one of the FIGS. 1, 2, 6, 10, 11, 12, and/or 14 and utilizing, for example, the processes and/or algorithms described herein in relation to FIGS. 4, 5, 7, 8A, 8B, 9A, 9B, 13, and/or 15.

The following provides an overview of aspects of the present disclosure:

Aspect 1: A first network node, comprising: a memory, and a processor coupled to the memory, wherein the processor is configured to: receive a plurality of reference signals, wherein each of the plurality of reference signals corresponds to a respective identifier of a plurality of identifiers; and transmit prediction information indicative of a predicted beam blockage event, wherein the prediction information is based on measurement information corresponding to the plurality of reference signals during a time period.

Aspect 2: The first network node of aspect 1, wherein the processor is configured to: obtain the measurement information during the time period.

Aspect 3: The first network node of aspect 2, wherein to obtain the measurement information during the time period, the processor is configured to perform one or more measurements during the time period to generate the measurement information.

Aspect 4: The first network node of any of aspects 1 through 3, wherein the plurality of reference signals includes a first type of one or more beam failure detection-reference signals (BFD-RSs), a second type of one or more BFD-RSs, or a combination thereof.

Aspect 5: The first network node of any of aspects 1 through 4, wherein the measurement information includes respective reference signal received power (RSRP) information for each respective reference signal of the plurality of reference signals.

Aspect 6: The first network node of any of aspects 1 through 5, wherein the processor is configured to: receive prediction configuration information, wherein the prediction configuration information includes information indicative of at least one of: a length of the time period, a statistical metric used to predict the predicted beam blockage event, a threshold value that is compared to the statistical metric, an occurrence of the predicted beam blockage event, an instance of the predicted beam blockage event, a severity of the predicted beam blockage event, or a bearing of an object corresponding to the predicted beam blockage event.

Aspect 7: The first network node of any of aspects 1 through 6, wherein the measurement information is based on the prediction configuration information.

Aspect 8: The first network node of any of aspects 1 through 7, wherein the prediction information is based on the prediction configuration information.

Aspect 9: The first network node of any of aspects 1 through 8, wherein the measurement information includes a plurality of reference signal received power measurements corresponding to a respective plurality of beam identification values as a function of time, wherein the processor is configured to compare the statistical metric associated with the plurality of reference signal received power measurements to the threshold value, and wherein, to transmit the prediction information, the processor is configured to transmit the prediction information based on the comparison.

Aspect 10: The first network node of any of aspects 1 through 9, wherein the processor is configured to: provide the measurement information to a model, and obtain, as an output from the model, the prediction information.

Aspect 11: The first network node of any of aspects 1 through 10, wherein the processor is configured to: receive, from a second network node, the model or information indicative of the model.

Aspect 12: The first network node of any of aspects 1 through 11, wherein the model includes a neural network.

Aspect 13: The first network node of any of aspects 1 through 12, wherein neural network training of the neural network utilizes a plurality of spectrograms from at least one of the first network node or a plurality of other network nodes, each of the plurality of spectrograms comprising a respective set of respective beam measurements of each respective reference signal associated with each respective beam identifier as a function of time.

Aspect 14: The first network node of any of aspects 1 through 13, wherein, to provide the measurement information to the model, the processor is configured to: transmit the measurement information to a second network node.

Aspect 15: The first network node of any of aspects 1 through 14, wherein the prediction information indicative of the predicted beam blockage event includes at least one of: information indicative of an instance of the predicted beam blockage event, information indicative of a severity of the predicted beam blockage event, or information indicative of a bearing of an object corresponding to the predicted beam blockage event.

Aspect 16: The first network node of any of aspects 1 through 15, wherein the information indicative of the instance of the predicted beam blockage event corresponds to a prediction of a start of the predicted beam blockage event in the time domain.

Aspect 17: The first network node of any of aspects 1 through 16, wherein the information indicative of the severity of the predicted beam blockage event corresponds to a duration of the predicted beam blockage event.

Aspect 18: The first network node of any of aspects 1 through 17, wherein the information indicative of the bearing of the object corresponding to the predicted beam blockage event includes information indicative of a motion direction corresponding to the predicted beam blockage event relative to the first network node.

Aspect 19: The first network node of any of aspects 1 through 18, wherein the processor is configured to: receive prediction configuration information, wherein the prediction configuration information includes information indicative of a format of the prediction information, wherein the prediction information complies with the format.

Aspect 20: The first network node of any of aspects 1 through 19, wherein the prediction information indicative of the predicted beam blockage event includes information indicative of when the predicted beam blockage event is predicted to occur.

Aspect 21: The first network node of any of aspects 1 through 20, wherein the prediction information indicative of the predicted beam blockage event includes information indicative of a duration of the predicted beam blockage event.

Aspect 22: The first network node of any of aspects 1 through 21, wherein the prediction information indicative of the predicted beam blockage event includes information indicative of a bearing of an object corresponding to the predicted beam blockage event.

Aspect 23: The first network node of any of aspects 1 through 22, wherein, to transmit the prediction information, the processor is configured to transmit the prediction information based on at least one of: a time at which the predicted beam blockage event is predicted to occur, a predicted duration of the predicted beam blockage event, or a bearing of an object corresponding to the predicted beam blockage event.

Aspect 24: A method at a first network node, comprising: receiving a plurality of reference signals, wherein each of the plurality of reference signals corresponds to a respective identifier of a plurality of identifiers; and transmitting prediction information indicative of a predicted beam blockage event, wherein the prediction information is based on measurement information corresponding to the plurality of reference signals during a time period.

Aspect 25: The method of aspect 24, further comprising: receiving prediction configuration information, wherein the prediction configuration information includes information indicative of at least one of: a length of the time period, a statistical metric used to predict the predicted beam blockage event, a threshold value that is compared to the statistical metric, an occurrence of the predicted beam blockage event, an instance of the predicted beam blockage event, a severity of the predicted beam blockage event, or a bearing of an object corresponding to the predicted beam blockage event.

Aspect 26: The method of aspect 24 or 25, further comprising: providing the measurement information to a model, and obtaining, as an output from the model, the prediction information.

Aspect 27: A first network node comprising: a memory, and a processor coupled to the memory, wherein the processor is configured to: transmit a plurality of reference signals, wherein each reference signal of the plurality of reference signals corresponds to a respective identifier of a plurality of identifiers, receive measurement information corresponding to the plurality of reference signals during a time period; and transmit prediction information indicative of a predicted beam blockage event, wherein the prediction information is based on the measurement information.

Aspect 28: The first network node of aspect 27, wherein the processor is configured to: transmit prediction configuration information, wherein the prediction configuration information includes information indicative of at least one of: a length of the time period, a statistical metric used to predict the predicted beam blockage event, a threshold value that is compared to the statistical metric, an occurrence of the predicted beam blockage event, an instance of the predicted beam blockage event, a severity of the predicted beam blockage event, or a bearing of an object corresponding to the predicted beam blockage event.

Aspect 29: The first network node of aspect 27 or 28, wherein the processor is configured to: transmit, to a second network node, a model or information indicative of the model.

Aspect 30: The first network node of any of aspects 27 through 29, wherein the model includes a neural network.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-15 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-15 may be configured to perform one or more of the methods, features, or steps described herein. The novel algorithms described herein may also be efficiently implemented in software and/or embedded in hardware.

The specific order or hierarchy of steps in the methods disclosed is an illustration of exemplary processes. In some examples, the specific order or hierarchy of steps in the methods may be rearranged. Any method disclosed herein presents elements of the various steps in a sample order and is not limited to the specific order or hierarchy presented unless specifically recited therein. While some examples illustrated herein depict only time and frequency domains, additional domains such as a spatial domain are also contemplated in this disclosure.

This disclosure enables any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular does not mean “one and only one” unless specifically so recited, and instead means “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. The construct A and/or B is intended to cover: A; B; and A and B. The word “obtain” as used herein may mean, for example, acquire, calculate, construct, derive, determine, receive, and/or retrieve. The preceding list is exemplary and not limiting.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

All structural and functional equivalents to the elements of the various aspects described throughout this disclosure that are known or later come to be known are expressly incorporated herein by reference and are intended to be encompassed by the claims. Nothing disclosed herein is dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A first network node, comprising:
a memory; and
a processor coupled to the memory, wherein the processor is configured to:
receive a plurality of reference signals, wherein each of the plurality of reference signals corresponds to a respective identifier of a plurality of identifiers; and
transmit prediction information indicative of a predicted beam blockage event, wherein the prediction information is based on measurement information corresponding to the plurality of reference signals during a time period.

2. The first network node of claim 1, wherein the processor is configured to:
obtain the measurement information during the time period.

3. The first network node of claim 2, wherein to obtain the measurement information during the time period, the processor is configured to perform one or more measurements during the time period to generate the measurement information.

4. The first network node of claim 1, wherein the plurality of reference signals includes a first type of one or more beam failure detection-reference signals (BFD-RSs), a second type of one or more BFD-RSs, or a combination thereof.

5. The first network node of claim 1, wherein the measurement information includes respective reference signal received power (RSRP) information for each respective reference signal of the plurality of reference signals.

6. The first network node of claim 1, wherein the processor is configured to:
receive prediction configuration information, wherein the prediction configuration information includes information indicative of at least one of:
a length of the time period,
a statistical metric used to predict the predicted beam blockage event,
a threshold value that is compared to the statistical metric,
an occurrence of the predicted beam blockage event,
an instance of the predicted beam blockage event,
a severity of the predicted beam blockage event, or
a bearing of an object corresponding to the predicted beam blockage event.

7. The first network node of claim 6, wherein the measurement information is based on the prediction configuration information.

8. The first network node of claim 6, wherein the prediction information is based on the prediction configuration information.

9. The first network node of claim 6, wherein the measurement information includes a plurality of reference signal received power measurements corresponding to a respective plurality of beam identification values as a function of time, wherein the processor is configured to compare the statistical metric associated with the plurality of reference signal received power measurements to the threshold value, and wherein, to transmit the prediction information, the processor is configured to transmit the prediction information based on the comparison.

10. The first network node of claim 1, wherein the processor is configured to:
provide the measurement information to a model; and
obtain, as an output from the model, the prediction information.

11. The first network node of claim 10, wherein the processor is configured to:
receive, from a second network node, the model or information indicative of the model.

12. The first network node of claim 10, wherein the model includes a neural network.

13. The first network node of claim 12, wherein neural network training of the neural network utilizes a plurality of spectrograms from at least one of the first network node or a plurality of other network nodes, each of the plurality of spectrograms comprising a respective set of respective beam measurements of each respective reference signal associated with each respective beam identifier as a function of time.

14. The first network node of claim 10, wherein, to provide the measurement information to the model, the processor is configured to:
transmit the measurement information to a second network node.

15. The first network node of claim 1, wherein the prediction information indicative of the predicted beam blockage event includes at least one of:
information indicative of an instance of the predicted beam blockage event,
information indicative of a severity of the predicted beam blockage event, or
information indicative of a bearing of an object corresponding to the predicted beam blockage event.

16. The first network node of claim 15, wherein the information indicative of the instance of the predicted beam blockage event corresponds to a prediction of a start of the predicted beam blockage event in the time domain.

17. The first network node of claim 15, wherein the information indicative of the severity of the predicted beam blockage event corresponds to a duration of the predicted beam blockage event.

18. The first network node of claim 15, wherein the information indicative of the bearing of the object corresponding to the predicted beam blockage event includes information indicative of a motion direction corresponding to the predicted beam blockage event relative to the first network node.

19. The first network node of claim 1, wherein the processor is configured to:
receive prediction configuration information, wherein the prediction configuration information includes information indicative of a format of the prediction information, wherein the prediction information complies with the format.

20. The first network node of claim 1, wherein the prediction information indicative of the predicted beam blockage event includes information indicative of when the predicted beam blockage event is predicted to occur.

21. The first network node of claim 1, wherein the prediction information indicative of the predicted beam blockage event includes information indicative of a duration of the predicted beam blockage event.

22. The first network node of claim 1, wherein the prediction information indicative of the predicted beam blockage event includes information indicative of a bearing of an object corresponding to the predicted beam blockage event.

23. The first network node of claim 1, wherein, to transmit the prediction information, the processor is configured to transmit the prediction information based on at least one of:
a time at which the predicted beam blockage event is predicted to occur,
a predicted duration of the predicted beam blockage event, or
a bearing of an object corresponding to the predicted beam blockage event.

24. A method at a first network node, comprising:
receiving a plurality of reference signals, wherein each of the plurality of reference signals corresponds to a respective identifier of a plurality of identifiers; and
transmitting prediction information indicative of a predicted beam blockage event, wherein the prediction information is based on measurement information corresponding to the plurality of reference signals during a time period.

25. The method of claim 24, further comprising:
receiving prediction configuration information, wherein the prediction configuration information includes information indicative of at least one of:
a length of the time period,
a statistical metric used to predict the predicted beam blockage event,
a threshold value that is compared to the statistical metric,
an occurrence of the predicted beam blockage event,
an instance of the predicted beam blockage event,
a severity of the predicted beam blockage event, or
a bearing of an object corresponding to the predicted beam blockage event.

26. The method of claim 24, further comprising:
providing the measurement information to a model; and
obtaining, as an output from the model, the prediction information.

27. A first network node comprising:
a memory; and
a processor coupled to the memory, wherein the processor is configured to:
transmit a plurality of reference signals, wherein each reference signal of the plurality of reference signals corresponds to a respective identifier of a plurality of identifiers;
receive measurement information corresponding to the plurality of reference signals during a time period; and
transmit prediction information indicative of a predicted beam blockage event, wherein the prediction information is based on the measurement information.

28. The first network node of claim 27, wherein the processor is configured to:
transmit prediction configuration information, wherein the prediction configuration information includes information indicative of at least one of:
a length of the time period,
a statistical metric used to predict the predicted beam blockage event,
a threshold value that is compared to the statistical metric,
an occurrence of the predicted beam blockage event,
an instance of the predicted beam blockage event,
a severity of the predicted beam blockage event, or
a bearing of an object corresponding to the predicted beam blockage event.

29. The first network node of claim 27, wherein the processor is configured to:
transmit, to a second network node, a model or information indicative of the model.

30. The first network node of claim 29, wherein the model includes a neural network.
